(19) United States
(12) Patent Application Publication
(10) Pub. No.: US 2016/0280829 A1
(43) Pub. Date: Sep. 29, 2016

(54) RESIN COMPOSITION FOR FORMING OPTICAL WAVEGUIDE, RESIN FILM FOR FORMING OPTICAL WAVEGUIDE, AND OPTICAL WAVEGUIDE USING THE SAME

(71) Applicant: HITACHI CHEMICAL COMPANY, LTD., Tokyo (JP)

(72) Inventors: Masao UCHIGASAKI, Tsukuba (JP); Daichi SAKAI, Tsukuba (JP); Toshihiro KURODA, Tsukuba (JP)

(73) Assignee: HITACHI CHEMICAL COMPANY, LTD., Tokyo (JP)

(21) Appl. No.: 14/914,703

(22) PCT Filed: Aug. 30, 2013
(86) PCT No.: PCT/JP2013/074006

§ 371 Date: Feb. 26, 2016

(51) Int. Cl. C08F 265/06; G02B 1/04; G02B 6/02

(52) U.S. Cl. CPC C08F 265/06; G02B 6/02033; G02B 1/046; B32B 37/1009

(57) ABSTRACT

The present invention provides a resin composition for an optical waveguide and a resin film for optical waveguides, the composition and the film being soluble in an aqueous alkaline solution, being patternable as required by alkali development, and exhibiting a lower optical propagation loss at a wavelength of from 830 to 850 nm, and an optical waveguide using the composition or the film. The resin composition for an optical waveguide according to the present invention includes (A) a polymer, (B) a polymerizable compound, and (C) a polymerization initiator. A refractive index A of the film after irradiation with UV light and heat-curing and a refractive index B of the film after irradiation with UV light, immersion in an alkali developer, and then heat-curing satisfy the relationship of A>B. As an optical waveguide produced by alkali development using the resin composition according to the present invention has, on at least part of the periphery of a core pattern that forms a core layer, a portion having a refractive index that is lower than the refractive index of the central portion of the core pattern, the optical waveguide is effective in preventing light travelling through the core layer from leaking out into the cladding layer, which can lower optical propagation loss.

### TECHNICAL FIELD

The present invention relates to a resin composition for an optical waveguide, a resin film for forming an optical waveguide, and an optical waveguide using the composition or the film and, in particular, to a resin composition for an optical waveguide, the composition having high transparency (low optical propagation loss) and being soluble in an aqueous alkaline solution, a resin film for an optical waveguide, the film including the resin composition, and an optical waveguide using the composition or the film.

### BACKGROUND OF THE INVENTION

In recent years, conventional electrical circuits for transmitting high-speed, high-density signals between electronic elements or between circuit boards has begun to limit improvements in speed and density, due to interference between signals and attenuation of signals. To overcome the limitation, techniques for optical connection between electronic elements and between circuit boards, the techniques being referred to as optical interconnection have been being explored. Polymer optical waveguides have received attention as optical transmission paths, from the standpoint of their high processability, low cost, high circuit-flexibility, and higher density.

Suitable examples of the polymer optical waveguides may include waveguides that are formed on a glass epoxy substrate for application to opto-electric circuit boards and flexible waveguides that include no hard support-substrate for connection between boards.

In addition to transparency (low optical propagation loss), the polymer optical waveguides are needed to have high heat-resistance, from the standpoint of, for example, the environment of use of a device to which the waveguides are applied and mounting of components. To meet needs for greater freedom to design optical interconnection, sophistication of devices, and simplification of processes, it is desirable for the waveguides to be made from a material that can form a pattern as required by exposure and development. Contemplated development methods include use of a solvent developer and use of an alkaline developer, and the use of an alkaline developer is desired for environmental and safety reasons. Known examples of optical waveguide materials that meet such needs include materials using a (meth)acrylic polymer (see, for example, Patent Literature 1).

Although a resin composition for an optical waveguide, the composition using a (meth)acrylic polymer, as described in the patent literature, can be developed using an alkaline developer and exhibits an optical propagation loss of 0.3 dB/cm at a wavelength of 850 nm, the loss value is not necessarily sufficient to meet the need for optical transmission of high-speed, high-density signals.

### PATENT LITERATURE 1

Japanese Patent No. 4241874

### SUMMARY OF THE INVENTION

The present invention is provided to solve the above problem and has an object to provide a resin composition for an optical waveguide and a resin film for optical waveguides, the composition and the film being soluble in an aqueous alkaline solution, being patternable as required by alkali development, and exhibiting a lower optical propagation loss at a wavelength of from 830 to 850 nm, and an optical waveguide using the composition or the film.

As a result of assiduous research, the present inventors have found that a resin composition for forming an optical waveguide, the composition including (A) a polymer, (B) a polymerizable compound, and (C) a polymerization initiator and satisfying a condition for refractive index under specific measurement-conditions or using a specific compound, has high transparency (low optical propagation loss) and is preferably developable in an alkali developer and that use of the composition can provide a resin film for an optical waveguide and an optical waveguide, the film and the waveguide having high transparency (low optical propagation loss) and being developable in an alkali developer.

That is, the present invention relates to following.

(1) A resin composition for forming an optical waveguide, the composition comprising: (A) a polymer; (B) a polymerizable compound; and (C) a polymerization initiator; wherein a refractive index A at a predetermined wavelength (λ) in the range of from 830 to 850 nm of a film produced by forming the composition into a film, irradiating the film with UV light (at a wavelength of 365 nm) at a predetermined dose (X) in the range of from 1000 to 4000 mJ/cm², and then heating the film at a predetermined temperature (T1) in the range of from 160 to 180° C. for a predetermined period (H1) in the range of from 0.5 to 3 hours and a refractive index B at the predetermined wavelength (λ) of a film produced by forming the composition into a film, irradiating the film with UV light (at a wavelength of 365 nm) at the predetermined dose (X), then immersing the film in an aqueous potassium carbonate solution having a predetermined concentration (C1) in the range of from 0.5 to 5% by mass at a predetermined temperature (T2) in the range of from 20 to 40° C. for a predetermined period (H2) in the range of from 1 to 5 minutes, and then heating the film at the predetermined temperature (T1) for the predetermined period (H1) satisfy the relationship of A>B.

(2) A resin composition for forming an optical waveguide, the composition comprising: (A) a polymer; (B) a polymerizable compound; and (C) a polymerization initiator; wherein a refractive index A at a predetermined wavelength (λ) in the range of from 830 to 850 nm of a film produced by forming the composition into a film, irradiating the film with UV light (at a wavelength of 365 nm) at a predetermined dose (X) in the range of from 1000 to 4000 mJ/cm², and then heating the film at a predetermined temperature (T1) in the range of from 160 to 180° C. for a predetermined period (H1) in the range of from 0.5 to 3 hours and a refractive index C at the predetermined wavelength (λ) of a film produced by forming the composition into a film and irradiating the film with UV light (at a wavelength of 365 nm) at the predetermined dose (X) satisfy the relationship of A−C≧0.003.

(3) A resin composition for forming an optical waveguide, the composition comprising: (A) a polymer; (B) a polymerizable compound; and (C) a polymerization initiator; wherein a refractive index A at a predetermined wavelength (λ) in the range of from 830 to 850 nm of a film produced by forming the composition into a film, irradiating the film with UV light (at a wavelength of 365 nm) at a predetermined dose (X) in the range of from 1000 to 4000 mJ/cm², and then heating the film at a predetermined temperature (T1) in the range of from 160 to 180° C. for a predetermined period (H1) in the range of from 0.5 to 3 hours, a refractive index C at the predetermined wavelength (λ) of a film produced by forming the composition into a film and irradiating the film with UV light (at a wavelength of 365 nm) at the predetermined dose (X), and a refractive index D at the predetermined wavelength (λ) of a film produced by forming the composition into a film, irradiating the film with UV light (at a wavelength of 365 nm) at the predetermined dose (X), then immersing the film in an aqueous potassium carbonate solution having a predetermined concentration (C1) in the range of from 0.5 to 5% by mass at the predetermined temperature (T2) for the predetermined period (H2) satisfy the relationship of A−C>D−C.

(4) The resin composition for forming an optical waveguide according to the resin composition described in any one of the clauses (1) to (3) above, wherein a refractive index C at a predetermined wavelength (λ) in the range of from 830 to 850 nm of a film produced by forming the composition into a film and irradiating the film with UV light (at a wavelength of 365 nm) at a predetermined dose (X) in the range of from 1000 to 4000 mJ/cm² using a UV exposure device and a refractive index D at the predetermined wavelength (λ) of a film produced by forming the composition into a film, irradiating the film with UV light (at a wavelength of 365 nm) at the predetermined dose (X) using a UV exposure device, and then immersing the film in an aqueous potassium carbonate solution having a predetermined concentration (C1) in the range of from 0.5 to 5% by mass at a predetermined temperature (T2) in the range of from 20 to 40° C. for a predetermined period (H2) in the range of from 1 to 5 minutes satisfy the relationship of C<D.

(5) The resin composition for forming an optical waveguide according to the resin composition described in any one of the clauses (1) to (4) above, wherein the polymer (A) comprises an alkali-soluble polymer having a carboxyl group, and the polymerizable compound (B) comprises a compound having an epoxy group and an ethylenically unsaturated group per molecule.

(6) A resin composition for forming an optical waveguide, the composition comprising: (A) a polymer; (B) a polymerizable compound; and (C) a polymerization initiator, wherein the polymer (A) comprises an alkali-soluble polymer having a carboxyl group, and the polymerizable compound (B) comprises a compound having an epoxy group and an ethylenically unsaturated group per molecule.

(7) The resin composition for forming an optical waveguide according to the resin composition described in the clause (5) or the clause (6) above, wherein the compound having an epoxy group and an ethylenically unsaturated group per molecule contains an aliphatic ring or aromatic ring per molecule.

(8) The resin composition for forming an optical waveguide according to the resin composition described in any one of the clauses (5) to (7) above, wherein the compound having an epoxy group and an ethylenically unsaturated group per molecule has at least one epoxy group and at least one ethylenically unsaturated group per molecule.

(9) The resin composition for forming an optical waveguide according to the resin composition described in any one of the clauses (5) to (8) above, wherein the compound having an epoxy group and an ethylenically unsaturated group per molecule has a bisphenol backbone in its molecule.

(10) The resin composition for forming an optical waveguide according to the resin composition described in any one of the clauses (5) to (9) above, wherein the composition comprises, as the polymerizable compound (B), at least one of a compound containing two or more ethylenically unsaturated groups per molecule and a compound containing two or more epoxy groups per molecule, in addition to the compound containing an epoxy group and an ethylenically unsaturated group per molecule.

(11) The resin composition for forming an optical waveguide according to the resin composition described in any one of the clauses (5) to (10) above, wherein the polymer (A) having a carboxyl group has a weight average molecular weight of from 1,000 to 3,000,000.

(12) The resin composition for forming an optical waveguide according to the resin composition described in any one of the clauses (1) to (11) above, wherein the polymer (A) having a carboxyl group has a maleimide backbone in the main chain.

(13) The resin composition for forming an optical waveguide according to the resin composition described in any one of the clauses (1) to (12) above, wherein the polymer (A) is contained in an amount of from 10 to 85% by mass based on the total amount of the polymer (A) and the polymerizable compound (B), the polymerizable compound (B) is contained in an amount of from 15 to 90% by mass based on the total amount of the polymer (A) and the polymerizable compound (B), and the polymerization initiator (C) is contained in amount of from 0.1 to 10 parts by mass based on 100 parts by mass of the total amount of the polymer (A) and the polymerizable compound (B).

(14) The resin composition for forming an optical waveguide according to the resin composition described in clause 13, wherein the polymer (A) is contained in an amount of from 10 to 65% by mass based on the total amount of the polymer (A) and the polymerizable compound (B), and the polymerizable compound (B) is contained in an amount of from 35 to 90% by mass based on the total amount of the polymer (A) and the polymerizable compound (B).

(15) A resin film for forming an optical waveguide, the film comprising a resin layer that is obtained using the resin composition for forming an optical waveguide according to the resin composition described in any one of the clauses (1) to (14) above.

(16) The resin film for forming an optical waveguide according to the resin film described in clause 15, the film having a three-layered structure comprising a substrate film, the resin layer, and a protective film.

(17) An optical waveguide comprising: a lower cladding layer; a core array; and an upper cladding layer, wherein at least one of the lower cladding layer, the core array, and the upper cladding layer is formed using the resin composition for forming an optical waveguide according to the resin composition described in any one of the clauses (1) to (14) above or the resin film for forming an optical waveguide according to the resin film described in the clause (15) or the clause (16) above.

(18) The optical waveguide according to the optical waveguide described in the clause (17) above, wherein the core array is formed using the resin composition for forming an optical waveguide or the resin film for forming an optical waveguide.

(19) The optical waveguide according to the optical waveguide described in the clause (18) above, wherein light mainly travels through a high-refractive-index portion inside of the core array.

(20) The optical waveguide according to the optical waveguide described in any one of the clauses (17) to (19) above, wherein the waveguide exhibits an optical propagation loss equal to or less than 0.15 dB/cm at a wavelength of 850 nm.

(21) A method for producing an optical waveguide, the method comprising: laminating the resin composition for forming an optical waveguide according to the resin composition described in any one of the clauses (1) to (14) above or the resin film for forming an optical waveguide according to the resin film described in any of the clause (15) or the clause (16) above; exposing the composition or the film; developing the composition or the film in an alkali developer; and thermal-curing the composition or the film to form at least one of a lower cladding layer, a core array, and an upper cladding layer.

The resin composition for an optical waveguide according to the present invention and a resin film for an optical waveguide, the film being obtained using the resin composition, are soluble in an aqueous alkaline solution and relatively arbitrarily patternable. And an optical waveguide produced using the composition or the film has high transparency, a precise pattern, and low optical propagation loss.

### BRIEF DESCRIPTION OF THE DRAWINGS

FIGS. 1A and 1B are a cross-sectional view of an exemplary optical waveguide produced using a resin composition for forming an optical waveguide according to an embodiment of the present invention;

FIGS. 2A, 2B, 2C, and 2D are a cross-sectional view illustrating an exemplary construction of an optical waveguide according to an embodiment of the present invention; and

FIGS. 3A, 3B, 3C, 3D, and 3E are a cross-sectional view illustrating a method for producing an optical waveguide according to an embodiment of the present invention, the method including forming a lower cladding layer, a core array, and an upper cladding layer using a resin film for forming an optical waveguide.

### DETAILED DESCRIPTION OF THE PREFERRED EMBODIMENTS

The present inventors have found that when a resin composition for forming an optical waveguide is developed in an alkali development to form a core array, a surface layer of the core pattern has an increased refractive index, and light travelling through the core array leaks out, which lowers total light transmission and thus increases optical loss. To investigate the cause, the present inventors derived a following approximate expression for refractive index of polymers from the Lorentz-Lorenz equation:

[Formula 1]

Refractive Index n≈Constant a×Polarizability (α)×Material Density (V)+b (1)

Then, the present inventors determined that the cause is that alkali cations (for example, potassium ions) penetrate into a surface layer of the formed pattern during alkali development, and thus the polarizability (α) is increased. To solve the problem, the present inventors paid attention to the material density (V) in the above formula and assumed that if an increase in refractive index due to increase in internal material-density (V) is greater than increase in polarizability (α) of the surface layer, the refractive index of an inner portion can be higher than the refractive index of the surface layer. Then, the present inventors investigated overall properties and components of the material to achieve the present invention.

According to a first embodiment of the present invention, a resin composition for forming an optical waveguide includes (A) a polymer, (B) a polymerizable compound, and (C) a polymerization initiator. In the first embodiment, a refractive index A at a predetermined wavelength (λ) in the range of from 830 to 850 nm of a film produced by forming the composition into a film, irradiating the film with UV light (at a wavelength of 365 nm) at a predetermined dose (X) in the range of from 1000 to 4000 mJ/cm² using a UV exposure device, and then heating the film at a predetermined temperature (T1) in the range of from 160 to 180° C. for a predetermined period (H1) in the range of from 0.5 to 3 hours and a refractive index B at the predetermined wavelength (λ) of a film produced by forming the composition into a film, irradiating the film with UV light (at a wavelength of 365 nm) at the predetermined dose (X) using a UV exposure device, then immersing the film in an aqueous potassium carbonate solution having a predetermined concentration (C1) in the range of from 0.5 to 5% by mass at a predetermined temperature (T2) in the range of from 20 to 40° C. for a predetermined period (H2) in the range of from 1 to 5 minutes, and then heating the film at the predetermined temperature (T1) for the predetermined period (H1) satisfy the relationship of A>B.

When the resin composition is used as a resin for forming a core layer in production of an optical waveguide, a periphery of a film of the composition is usually exposed to an alkaline solution such as, for example, an aqueous potassium carbonate solution during formation of the core pattern, and thus at least part of a peripheral surface layer of the formed core pattern has a low refractive index portion having a refractive index that is lower than the refractive index of a center of the core pattern. This allows light to mainly travel close the center of the core pattern, which can reduce the optical loss. The core pattern is given a rectangular peripheral profile such as, for example, a rectangular cross-sectional profile by sufficiently immersing the core pattern in the alkaline solution after etching to form the pattern or during forming the pattern. When the core pattern is formed on a lower cladding layer, the core pattern can have low refractive index portions on three sides including two sides of both the sidewalls and the top side, which can further reduce the optical loss. The optical loss can be further reduced by disposing, outward of the low refractive index portions, at least one of a lower cladding layer and an upper cladding layer having a refractive index that is lower than the refractive index of the low refractive index portions.

In the first embodiment of the composition, it is also preferred that a refractive index C at a wavelength of, for example, 830 nm of a film produced by forming the composition into a film and irradiating the film with UV light (at a wavelength of 365 nm) at, for example, 2500 mJ/cm² using a UV exposure device and a refractive index D at a wavelength of 830 nm of a film produced by forming the composition into a film, irradiating the film with UV light (at a wavelength of 365 nm) at 2500 mJ/cm² using a UV exposure device, then immersing the film in an aqueous potassium carbonate solution having a predetermined concentration (C1) in the range of from 0.5 to 5% by mass (for example, a 1% by mass aqueous solution of potassium carbonate) at a temperature of, for example, 30° C. for 2 minutes satisfy the relationship of C<D. Such property facilitates penetration of cations into the periphery of the pattern. The effect of the cations in inhibition of the thermal crosslinking reaction during heat-curing can provide a surface layer that exhibits a lower increase in crosslinking density compared with the inner portions. This allows light to mainly travel close to the center of the pattern, which can reduce the optical loss. This also applies to second and third embodiments described below.

Even after irradiation with UV light, the resin composition is expected to be dissolved out from the portions exposed to the aqueous alkaline solution into the aqueous alkaline solution to a certain degree, compared with the central portion of the cores, the central portion being unaffected by the aqueous alkaline solution. Thus, it can be expected that the portions exposed to the aqueous alkaline solution exhibit lower increase in the material density (V) in the above Formula 1 and thus have a low refractive index. The phenomenon is also effective in reducing the optical propagation loss.

According to the second embodiment of the present invention, a resin composition for forming an optical waveguide includes (A) a polymer, (B) a polymerizable compound, and (C) a polymerization initiator. In the second embodiment, a refractive index A at a predetermined wavelength (λ) in the range of from 830 to 850 nm of a film produced by forming the composition into a film, irradiating the film with UV light (at a wavelength of 365 nm) at a predetermined dose (X) in the range of from 1000 to 4000 mJ/cm², and then heating the film at a predetermined temperature (T1) in the range of from 160 to 180° C. for a predetermined period (H1) in the range of from 0.5 to 3 hours and a refractive index C at the predetermined wavelength (λ) of a film produced by forming the composition into a film and irradiating the film with UV light (at a wavelength of 365 nm) at the predetermined dose (X) satisfy the relationship of A−C≧0.003.

Satisfaction of the relationship results in a high increase in refractive index after thermal-curing, and thus the increase in refractive index of the central portion of the pattern can be greater than an increase in refractive index of the periphery of the pattern. This allows light to mainly travel through the central portion of the pattern, which can reduce the optical propagation loss.

According to the third embodiment of the present invention, a resin composition for forming an optical waveguide exhibits the refractive indices A to D that satisfy the relationship of A−C>D−C. This means that the degree of change (increase) in refractive index due to increase in material density due to thermal-curing is higher than the degree of change (increase) in refractive index due to increase in polarizability due to presence of the cations. This allows decrease in refractive index due to decrease in material density due to thermal-curing to contribute more than increase in refractive index due to presence of the cations, which is a requirement for producing the refractive index difference in the present invention.

Preferably, the specific value of A−C is equal to or more than 0.003. A significantly large refractive-index-difference can prevent light from traveling through the low refractive index portions with reduced total light transmission. In view of the foregoing, the value of A−C is more preferably equal to or more than 0.005 and especially preferably equal to or more than 0.008.

In the first to third embodiments, the refractive indices measured using samples produced under various conditions need to be unaffected by factors other than physical properties of the material. Thus, the refractive indices of compositions in the same form are compared using the same conditions such as the UV light dose, the heating temperature, the heating period, the temperature and the period during immersion in an alkali developer, and the wavelength for measuring the refractive indices. The range of these conditions as specified above can depend on conditions actually used for producing an optical waveguide according to the present invention.

In particular, the composition is irradiated with UV light usually at a predetermined dose (X) in the range of from 1000 to 4000 mJ/cm² and preferably at a predetermined dose in the range of from 2000 to 3500 mJ/cm², which is frequently used for producing an optical waveguide. Irradiation at a predetermined dose in the range of from 2500 to 3500 mJ/cm², which is mainly used for reviewing the conditions for producing an optical waveguide, allows standard comparison of the refractive indices, and thus it can be more preferred to use a dose in such range. Optionally, the range of the irradiance may also be specified. In this case, the composition is irradiated at a predetermined irradiance in a range around 24 mW/cm² that is from 20 to 30 mW/cm². The conditions other than the UV light dose are not critical as long as the conditions are within the predetermined range as described above. Usually, the wavelength for measuring refractive indices is adjusted to fall within the wavelength range that is usually used for using an optical waveguide according to the present invention. As measurements of the refractive indices are affected by the measurement temperature, the refractive indices are compared at the same temperature. Usually, the refractive indices are measured at a predetermined room-temperature of from 15 to 30° C. (for example 25° C.).

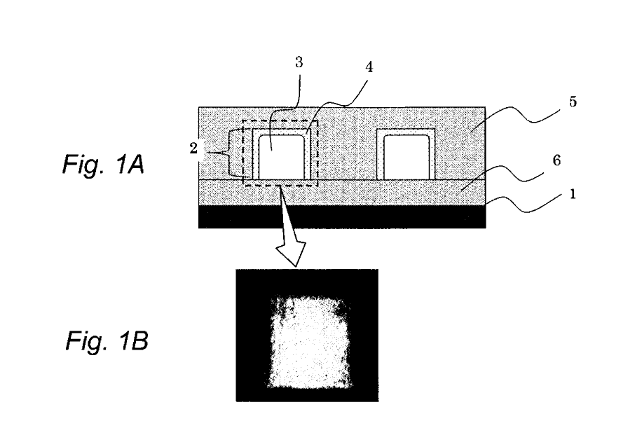

FIGS. 1A and 1B illustrate an exemplary optical waveguide produced using a resin composition for forming an optical waveguide according to the present invention, in accordance with the above principles. FIG. 1A schematically illustrates a cross-sectional view of the optical waveguide, and FIG. 1B is an enlarged photograph of a cross section of a core array in the optical waveguide (the portion bounded by the dashed line). As shown in FIGS. 1A and 1B, a core pattern 2 of an optical waveguide 1 includes a central portion 3 and a low refractive index portion 4. A lower cladding layer 6 having a lower refractive index and an upper cladding layer 5 on a substrate 7, the cladding layers being disposed outward of the low refractive index portion 4, efficiently allow light to travel within the core pattern 2 and prevent the light from leaking out of the low refractive index portion 4. Such optical waveguide facilitates propagation of light through the central portion 3 of the core pattern 2 that is, for example, linear, with low optical loss. As the light undergoes total internal reflection at the interface between the upper cladding layer 5 and the core pattern 2 and the interface between the lower cladding layer 6 and the core pattern 2, the interfaces exhibiting a larger difference in refractive index, the light is prevented from leaking out of the core pattern 2 due to, for example, a bend in the core pattern 2, which reduces the optical loss.

To implement the first to the third embodiments of the present invention, a resin composition for forming an optical waveguide includes (A) a polymer, (B) a polymerizable compound, and (C) a polymerization initiator. The component (A) is an alkali-soluble polymer having a carboxyl group, and the component (B) includes a compound having an epoxy group and an ethylenically unsaturated group in its molecule. Through use of such component (A) and such component (B), the above properties are achieved. This allows light to travel mainly close to the center of the pattern, which can reduce the optical loss.

Now, each of the components of the composition for forming an optical waveguide according to the present invention will be described in detail.

Component (A)

Preferably, the polymer as the component (A) is generally alkali-soluble. The alkali-soluble polymer refers to a polymer having an alkali-soluble group (such as, for example, a carboxyl group, a sulfonic group, a phenolic hydroxyl group, an alcoholic hydroxyl group, and an amino group) and may be any polymer as long as the polymer is soluble in an aqueous alkaline solution. The polymer is not particularly restricted and is preferably an alkali-soluble (meth)acrylic polymer. Preferably, the alkali-soluble group is a carboxyl group.

The term (meth)acrylic means at least one of acrylic and methacrylic.

The alkali-soluble (meth)acrylic polymer (A) is not particularly restricted as long as the polymer is soluble in a developer containing an aqueous alkaline solution and has sufficient solubility to carry out a particular development process. The preferred examples include polymers of (meth)acrylic monomers such as (meth)acrylic acid, (meth)acrylic esters (such as (meth)acrylic alkyl ester and (meth)acrylic acid hydroxy alkyl ester), and (meth)acrylamide, and polymers of such monomers and other monomers containing a polymerizable unsaturated group (such as styrene, α-methyl styrene, maleic anhydride, and N-substituted or unsubstituted maleimide monomers).

Among them, polymers of monomers having a maleimide backbone using N-substituted maleimide are preferred, and copolymers of such monomers and other (meth)acrylic monomers are more preferred, from the standpoint of transparency, heat resistance, and solubility in an aqueous alkaline solution. It is more preferred to use an alkali-soluble (meth)acrylic polymer that includes structural units (A-1) and (A-2) respectively represented by following general formulas (1) and (2) in the main chain and at least one of structural units (A-3) and (A-4) respectively represented by following general formulas (3) and (4).

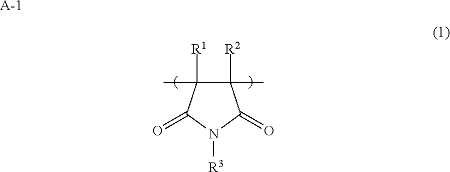

(In the formula, R¹ to R³ each independently represent a hydrogen atom or an organic group having from 1 to 20 carbon atoms.)

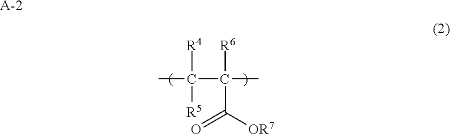

(In the formula, R⁴ to R⁶ each independently represent a hydrogen atom or an organic group having from 1 to 20 carbon atoms, and R⁷ represents an organic group having from 1 to 20 carbon atoms.)

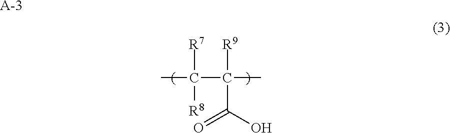

(In the formula, R⁷ to R⁹ each independently represent a hydrogen atom or an organic group having from 1 to 20 carbon atoms.)

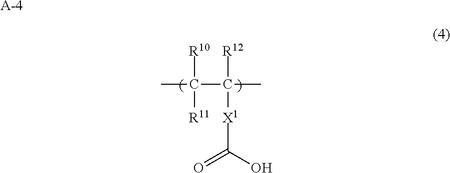

(In the formula, R¹⁰ to R¹² and X¹ each independently represent a hydrogen atom or an organic group having from 1 to 20 carbon atoms.)

Examples of the organic groups in the general formulas (1) to (4) include monovalent and divalent groups such as an alkyl group, a cycloalkyl group, an aryl group, an aralkyl group, a carbonyl group, an alkoxycarbonyl group, an aryloxycarbonyl group, and a carbamoyl group. The groups may be substituted with a group such as a hydroxyl group, a halogen atom, an alkyl group, a cycloalkyl group, an aryl group, an aralkyl group, a carbonyl group, an alkoxycarbonyl group, an aryloxycarbonyl group, a carbamoyl group, an alkoxy group, an aryloxy group, an alkylthio group, an arylthio group, an amino group, or a silyl group.

Preferably, the alkali-soluble (meth)acrylic polymer (A) includes the structural unit (A-1) from a maleimide backbone in an amount of from 3 to 50% by mass. The polymer (A) that includes the structural unit (A-1) in an amount equal to or more than 3% by mass has heat resistance due to the maleimide, while the polymer (A) that includes the structural unit (A-1) in an amount equal to or less than 50% by mass has sufficient transparency and thus prevents brittling of a resulting resin pattern. Thus, the polymer (A) more preferably includes the structural unit (A-1) in an amount of from 5 to 40% by mass and especially preferably from 10 to 30% by mass.

The structural unit (A-1) from a maleimide may have any structure as long as the unit is represented by the general formula (1).

Examples of the maleimide as a source of the structural unit (A-1) include alkylmaleimides such as N-methylmaleimide, N-ethylmaleimide, N-propylmaleimide, N-isopropylmaleimide, N-butylmaleimide, N-isobutylmaleimide, N-2-methyl-2-propylmaleimide, N-pentylmaleimide, N-2-pentylmaleimide, N-3-pentylmaleimide, N-2-methyl-1-butylmaleimide, N-2-methyl-2-butylmaleimide, N-3-methyl-1-butylmaleimide, N-3-methyl-2-butylmaleimide, N-hexylmaleimide, N-2-hexylmaleimide, N-3-hexylmaleimide, N-2-methyl-1-pentylmaleimide, N-2-methyl-2-pentylmaleimide, N-2-methyl-3-pentylmaleimide, N-3-methyl-1-pentylmaleimide, N-3-methyl-2-pentylmaleimide, N-3-methyl-3-pentylmaleimide, N-4-methyl-1-pentylmaleimide, N-4-methyl-2-pentylmaleimide, N-2,2-dimethyl-1-butylmaleimide, N-3,3-dimethyl-1-butylmaleimide, N-3,3-dimethyl-2-butylmaleimide, N-2,3-dimethyl-1-butylmaleimide, N-2,3-dimethyl-2-butylmaleimide, N-hydroxymethylmaleimide, N-1-hydroxyethylmaleimide, N-2-hydroxyethylmaleimide, N-1-hydroxy-1-propylmaleimide, N-2-hydroxy-1-propylmaleimide, N-3-hydroxy-1-propylmaleimide, N-1-hydroxy-2-propylmaleimide, N-2-hydroxy-2-propylmaleimide, N-1-hydroxy-1-butylmaleimide, N-2-hydroxy-1-butylmaleimide, N-3-hydroxy-1-butylmaleimide, N-4-hydroxy-1-butylmaleimide, N-1-hydroxy-2-butylmaleimide, N-2-hydroxy-2-butylmaleimide, N-3-hydroxy-2-butylmaleimide, N-4-hydroxy-2-butylmaleimide, N-2-methyl-3-hydroxy-1-propylmaleimide, N-2-methyl-3-hydroxy-2-propylmaleimide, N-2-methyl-2-hydroxy-1-propylmaleimide, N-1-hydroxy-1-pentylmaleimide, N-2-hydroxy-1-pentylmaleimide, N-3-hydroxy-1-pentylmaleimide, N-4-hydroxy-1-pentylmaleimide, N-5-hydroxy-1-pentylmaleimide, N-1-hydroxy-2-pentylmaleimide, N-2-hydroxy-2-pentylmaleimide, N-3-hydroxy-2-pentylmaleimide, N-4-hydroxy-2-pentylmaleimide, N-5-hydroxy-2-pentylmaleimide, N-1-hydroxy-3-pentylmaleimide, N-2-hydroxy-3-pentylmaleimide, N-3-hydroxy-3-pentylmaleimide, N-1-hydroxy-2-methyl-1-butylmaleimide, N-1-hydroxy-2-methyl-2-butylmaleimide, N-1-hydroxy-2-methyl-3-butylmaleimide, N-1-hydroxy-2-methyl-4-butylmaleimide, N-2-hydroxy-2-methyl-1-butylmaleimide, N-2-hydroxy-2-methyl-3-butylmaleimide, N-2-hydroxy-2-methyl-4-butylmaleimide, N-2-hydroxy-3-methyl-1-butylmaleimide, N-2-hydroxy-3-methyl-2-butylmaleimide, N-2-hydroxy-3-methyl-3-butylmaleimide, N-2-hydroxy-3-methyl-4-butylmaleimide, N-4-hydroxy-2-methyl-1-butylmaleimide, N-4-hydroxy-2-methyl-2-butylmaleimide, N-1-hydroxy-3-methyl-2-butylmaleimide, N-1-hydroxy-3-methyl-1-butylmaleimide, N-1-hydroxy-2,2-dimethyl-1-propylmaleimide, N-3-hydroxy-2,2-dimethyl-1-propylmaleimide, N-1-hydroxy-1-hexylmaleimide, N-1-hydroxy-2-hexylmaleimide, N-1-hydroxy-3-hexylmaleimide, N-1-hydroxy-4-hexylmaleimide, N-1-hydroxy-5-hexylmaleimide, N-1-hydroxy-6-hexylmaleimide, N-2-hydroxy-1-hexylmaleimide, N-2-hydroxy-2-hexylmaleimide, N-2-hydroxy-3-hexylmaleimide, N-2-hydroxy-4-hexylmaleimide, N-2-hydroxy-5-hexylmaleimide, N-2-hydroxy-6-hexylmaleimide, N-3-hydroxy-1-hexylmaleimide, N-3-hydroxy-2-hexylmaleimide, N-3-hydroxy-3-hexylmaleimide, N-3-hydroxy-4-hexylmaleimide, N-3-hydroxy-5-hexylmaleimide, N-3-hydroxy-6-hexylmaleimide, N-1-hydroxy-2-methyl-1-pentylmaleimide, N-1-hydroxy-2-methyl-2-pentylmaleimide, N-1-hydroxy-2-methyl-3-pentylmaleimide, N-1-hydroxy-2-methyl-4-pentylmaleimide, N-1-hydroxy-2-methyl-5-pentylmaleimide, N-2-hydroxy-2-methyl-1-pentylmaleimide, N-2-hydroxy-2-methyl-2-pentylmaleimide, N-2-hydroxy-2-methyl-3-pentylmaleimide, N-2-hydroxy-2-methyl-4-pentylmaleimide, N-2-hydroxy-2-methyl-5-pentylmaleimide, N-2-hydroxy-3-methyl-1-pentylmaleimide, N-2-hydroxy-3-methyl-2-pentylmaleimide, N-2-hydroxy-3-methyl-3-pentylmaleimide, N-2-hydroxy-3-methyl-4-pentylmaleimide, N-2-hydroxy-3-methyl-5-pentylmaleimide, N-2-hydroxy-4-methyl-1-pentylmaleimide, N-2-hydroxy-4-methyl-2-pentylmaleimide, N-2-hydroxy-4-methyl-3-pentylmaleimide, N-2-hydroxy-4-methyl-4-pentylmaleimide, N-2-hydroxy-4-methyl-5-pentylmaleimide, N-3-hydroxy-2-methyl-1-pentylmaleimide, N-3-hydroxy-2-methyl-2-pentylmaleimide, N-3-hydroxy-2-methyl-3-pentylmaleimide, N-3-hydroxy-2-methyl-4-pentylmaleimide, N-3-hydroxy-2-methyl-5-pentylmaleimide, N-1-hydroxy-4-methyl-1-pentylmaleimide, N-1-hydroxy-4-methyl-2-pentylmaleimide, N-1-hydroxy-4-methyl-3-pentylmaleimide, N-1-hydroxy-4-methyl-pentylmaleimide, N-1-hydroxy-3-methyl-1-pentylmaleimide, N-1-hydroxy-3-methyl-2-pentylmaleimide, N-1-hydroxy-3-methyl-3-pentylmaleimide, N-1-hydroxy-3-methyl-4-pentylmaleimide, N-1-hydroxy-3-methyl-5-pentylmaleimide, N-3-hydroxy-3-methyl-1-pentylmaleimide, N-3-hydroxy-3-methyl-2-pentylmaleimide, N-1-hydroxy-3-ethyl-4-butylmaleimide, N-2-hydroxy-3-ethyl-4-butylmaleimide, N-2-hydroxy-2-ethyl-1-butylmaleimide, N-4-hydroxy-3-ethyl-1-butylmaleimide, N-4-hydroxy-3-ethyl-2-butylmaleimide, N-4-hydroxy-3-ethyl-3-butylmaleimide, N-4-hydroxy-3-ethyl-4-butylmaleimide, N-1-hydroxy-2,3-dimethyl-1-butylmaleimide, N-1-hydroxy-2,3-dimethyl-2-butylmaleimide, N-1-hydroxy-2,3-dimethyl-3-butylmaleimide, N-1-hydroxy-2,3-dimethyl-4-butylmaleimide, N-2-hydroxy-2,3-dimethyl-1-butylmaleimide, N-2-hydroxy-2,3-dimethyl-3-butylmaleimide, N-2-hydroxy-2,3-dimethyl-4-butylmaleimide, N-1-hydroxy-2,2-dimethyl-1-butylmaleimide, N-1-hydroxy-2,2-dimethyl-3-butylmaleimide, N-1-hydroxy-2,2-dimethyl-4-butylmaleimide, N-2-hydroxy-3,3-dimethyl-1-butylmaleimide, N-2-hydroxy-3,3-dimethyl-2-butylmaleimide, N-2-hydroxy-3,3-dimethyl-4-butylmaleimide, N-1-hydroxy-3,3-dimethyl-1-butylmaleimide, N-1-hydroxy-3,3-dimethyl-2-butylmaleimide, and N-1-hydroxy-3,3-dimethyl-4-butylmaleimide; cycloalkylmaleimides such as N-cyclopropylmaleimide, N-cyclobutylmaleimide, N-cyclopentylmaleimide, N-cyclohexylmaleimide, N-cycloheptylmaleimide, N-cyclooctylmaleimide, N-2-methylcyclohexylmaleimide, N-2-ethylcyclohexylmaleimide, and N-2-chlorocyclohexylmaleimide; and arylmaleimides such as N-phenylmaleimide, N-2-methylphenylmaleimide, N-2-ethylphenylmaleimide, and N-2-chlorophenylmaleimide.

Among them, it is preferred to use cycloalkylmaleimides, and it is more preferred to use N-cyclohexylmaleimide or N-2-methylcyclohexylmaleimide, from the standpoint of transparency and solubility.

These compounds can be used alone or in combination of two or more thereof.

In the case of using the alkali-soluble (meth)acrylic polymer that includes a maleimide backbone in the main chain as the component (A), the polymer preferably includes the structural unit (A-2) from a (meth)acrylate in an amount of from 20 to 90% by mass. The polymer that includes the structural unit (A-2) in an amount equal to or more than 20% by mass has transparency due to the (meth)acrylate, while the polymer that includes the structural unit (A-2) in an amount equal to or less than 90% by mass has sufficient heat resistance. Thus, the polymer more preferably includes the structural unit (A-2) in an amount of from 25 to 85% by mass and especially preferably from 30 to 80% by mass.

The structural unit (A-2) from a (meth)acrylate may have any structure as long as the unit is represented by the general formula (2).

Examples of the (meth)acrylate used for the component (A) in the present invention (as a source of the structural unit (A-2) in a preferred example) include aliphatic (meth)acrylates such as methyl (meth)acrylate, ethyl (meth)acrylate, butyl (meth)acrylate, isobutyl (meth)acrylate, tert-butyl (meth)acrylate, butoxyethyl (meth)acrylate, isoamyl (meth)acrylate, hexyl (meth)acrylate, 2-ethylhexyl (meth)acrylate, heptyl (meth)acrylate, octylheptyl (meth)acrylate, nonyl (meth)acrylate, decyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth)acrylate, stearyl (meth)acrylate, behenyl (meth)acrylate, 2-hydroxyethyl (meth)acrylate, 2-hydroxypropyl (meth)acrylate, 3-chloro-2-hydroxypropyl (meth)acrylate, 2-hydroxybutyl (meth)acrylate, methoxy polyethylene glycol (meth)acrylate, ethoxy polyethylene glycol (meth)acrylate, methoxy polypropylene glycol (meth)acrylate, ethoxy polypropylene glycol (meth)acrylate, and mono(2-(meth)acryloyloxyethyl) succinate; cycloaliphatic (meth)acrylates such as cyclopentyl (meth)acrylate, cyclohexyl (meth)acrylate, dicyclopentanyl (meth)acrylate, dicyclopentenyl (meth)acrylate, isobornyl (meth)acrylate, mono(2-(meth)acryloyloxyethyl) tetrahydrophthalate, and mono(2-(meth)acryloyloxyethyl) hexahydrophthalate; aromatic (meth)acrylates such as benzyl (meth)acrylate, phenyl (meth)acrylate, o-biphenyl (meth)acrylate, 1-naphthyl (meth)acrylate, 2-naphthyl (meth)acrylate, phenoxyethyl (meth)acrylate, p-cumylphenoxyethyl (meth)acrylate, o-phenylphenoxyethyl (meth)acrylate, 1-naphthoxyethyl (meth)acrylate, 2-naphthoxyethyl (meth)acrylate, phenoxy polyethylene glycol (meth)acrylate, nonylphenoxy polyethylene glycol (meth)acrylate, phenoxy polypropylene glycol (meth)acrylate, 2-hydroxy-3-phenoxypropyl (meth)acrylate, 2-hydroxy-3-(o-phenylphenoxy)propyl (meth)acrylate, 2-hydroxy-3-(1-naphthoxy)propyl (meth)acrylate, and 2-hydroxy-3-(2-naphthoxy)propyl (meth)acrylate; heterocyclic (meth)acrylates such as 2-tetrahydrofurfuryl (meth)acrylate, N-(meth)acryloyloxyethyl hexahydrophthalimide, and 2-(meth)acryloyloxyethyl-N-carbazole, and caprolactone modifications thereof.

Among them, aliphatic (meth)acrylates such as methyl (meth)acrylate, ethyl (meth)acrylate, butyl (meth)acrylate, and 2-ethylhexyl (meth)acrylate; the cycloaliphatic (meth)acrylates; the aromatic (meth)acrylates; and the heterocyclic (meth)acrylates are preferred from the standpoint of transparency and heat resistance.

These compounds can be used alone or in combination of two or more thereof.

Preferably, the alkali-soluble (meth)acrylic polymer (A) includes the structural units (A-3) and (A-4) from a compound having a carboxyl group and an ethylenically unsaturated double bond in an amount of from 3 to 60% by mass. The polymer (A) that includes the structural units (A-3) and (A-4) in an amount equal to or more than 3% by mass is readily soluble in a developer that contains an aqueous alkaline solution, while the polymer (A) that includes the structural units (A-3) and (A-4) in an amount equal to or less than 60% by mass exhibits high developer resistance, which refers to the ability of portions that are not to be removed in development to form a pattern to resist a developer, in a development step of selectively removing a layer of a photosensitive resin composition by development as described below to form a pattern. In view of the foregoing, the polymer (A) more preferably includes the structural units (A-3) and (A-4) in an amount of from 5 to 50% by mass and especially preferably from 10 to 40% by mass.

The structural units (A-3) and (A-4) from a compound having a carboxyl group and an ethylenically unsaturated group has any structure as long as the structural units (A-3) and (A-4) are respectively represented by the general formulas (3) and (4).

Examples of the compound having a carboxyl group and an ethylenically unsaturated group as a source of the structural unit (A-3) include (meth)acrylic acid, maleic acid, fumaric acid, crotonic acid, itaconic acid, citraconic acid, mesaconic acid, and cinnamic acid. Among them, (meth)acrylic acid, maleic acid, fumaric acid, and crotonic acid are preferred from the standpoint of transparency and alkali solubility.

Alternatively, maleic anhydride may be used as the source and may be ring-opened with an appropriate alcohol such as methanol, ethanol, or propanol after polymerization and be converted into a structure of the structural unit (A-3). These compounds can be used alone or in combination of two or more thereof.

Examples of the compound having a carboxyl group and an ethylenically unsaturated group as a source of the structural unit (A-4) include mono(2-(meth)acryloyloxyethyl) succinate, mono(2-(meth)acryloyloxyethyl) phthalate, mono(2-(meth)acryloyloxyethyl) isophthalate, mono(2-(meth)acryloyloxyethyl) terephthalate, mono(2-(meth)acryloyloxyethyl) tetrahydrophthalate, mono(2-(meth)acryloyloxyethyl) hexahydrophthalate, mono(2-(meth)acryloyloxyethyl) hexahydroisophthalate, mono(2-(meth)acryloyloxyethyl) hexahydroterephthalate, ω-carboxy-polycaprolactone mono(meth)acrylate, 3-vinylbenzoic acid, and 4-vinylbenzoic acid.

Among them, mono(2-(meth)acryloyloxyethyl) succinate, mono(2-(meth)acryloyloxyethyl) tetrahydrophthalate, mono(2-(meth)acryloyloxyethyl) hexahydrophthalate, mono(2-(meth)acryloyloxyethyl) hexahydroisophthalate, and mono(2-(meth)acryloyloxyethyl) hexahydroterephthalate are preferred from the standpoint of transparency and alkali solubility.

These compounds can be used alone or in combination of two or more thereof.

The alkali-soluble (meth)acrylic polymer (A) may optionally include a structural unit other than the structural units (A-1) to (A-4).

Examples of a compound having an ethylenically unsaturated group as a source of such structural unit include, but are not limited to, styrene, α-methylstyrene, vinyl toluene, vinyl chloride, vinyl acetate, vinyl pyridine, N-vinyl pyrrolidone, N-vinyl carbazole, butadiene, isoprene, and chloroprene. Among them, styrene, α-methylstyrene, vinyl toluene, and N-vinyl carbazole are more preferred from the standpoint of heat resistance and transparency.

These compounds can be used alone or in combination of two or more thereof.

The alkali-soluble (meth)acrylic polymer (A) may be synthesized by any method, and, for example, the polymer (A) can be obtained by copolymerizing a maleimide as a source of the structural unit (A-1), a (meth)acrylate as a source of the structural unit (A-2), and a compound having a carboxyl group and an ethylenically unsaturated group as a source of at least one of the structural units (A-3) and (A-4), and optionally, another compound having an ethylenically unsaturated group in the presence of an appropriate polymerization initiator (preferably, a radical polymerization initiator). In the reaction, an organic solvent may be optionally used as a reaction solvent.

Examples of the polymerization initiator used in the present invention include, but are not limited to, ketone peroxides such as methyl ethyl ketone peroxide, cyclohexanone peroxide, and methyl cyclohexanone peroxide; peroxyketals such as 1,1-bis(t-butylperoxy)cyclohexane, 1,1-bis(t-butylperoxy)-2-methylcyclohexane, 1,1-bis(t-butylperoxy)-3,3,5-trimethylcyclohexane, 1,1-bis(t-hexylperoxy)cyclohexane, and 1,1-bis(t-hexylperoxy)-3,3,5-trimethylcyclohexane; hydroperoxides such as p-menthane hydroperoxide; dialkyl peroxides such as α,α′-bis(t-butylperoxy)diisopropylbenzene, dicumyl peroxide, t-butyl cumyl peroxide, and di-t-butyl peroxide; diacyl peroxides such as octanoyl peroxide, lauroyl peroxide, stearyl peroxide, and benzoyl peroxide; peroxy carbonates such as bis(4-t-butyl cyclohexyl)peroxy dicarbonate, di-2-ethoxyethyl peroxy dicarbonate, di-2-ethylhexyl peroxy dicarbonate, and di-3-methoxybutylperoxy carbonate; peroxy esters such as t-butylperoxy pivalate, t-hexylperoxy pivalate, 1,1,3,3-tetramethylbutyl peroxy-2-ethyl hexanoate, 2,5-dimethyl-2,5-bis(2-ethylhexanoylperoxy)hexane, t-hexylperoxy-2-ethyl hexanoate, t-butylperoxy-2-ethyl hexanoate, t-butylperoxy isobutyrate, t-hexylperoxy isopropyl monocarbonate, t-butylperoxy-3,5,5-trimethyl hexanoate, t-butylperoxy laurate, t-butylperoxy isopropyl monocarbonate, t-butylperoxy-2-ethylhexyl monocarbonate, t-butylperoxy benzoate, t-hexylperoxy benzoate, 2,5-dimethyl-2,5-bis(benzoylperoxy)hexane, and t-butylperoxy acetate; and azo compounds such as 2,2′-azobisisobutylonitrile, 2,2′-azobis(2,4-dimethylvaleronitrile), and 2,2′-azobis(4-methoxy-2′-dimethylvaleronitrile).

The organic solvent used as the reaction solvent is not particularly restricted as long as the solvent can dissolve the alkali-soluble polymer (A). The examples include aromatic hydrocarbons such as toluene, xylene, mesitylene, cumene, and p-cymene; cyclic ethers such as tetrahydrofuran and 1,4-dioxane; alcohols such as methanol, ethanol, isopropanol, butanol, ethylene glycol, and propylene glycol; ketones such as acetone, methyl ethyl ketone, methyl isobutyl ketone, cyclohexanone, and 4-hydroxy-4-methyl-2-pentanone; esters such as methyl acetate, ethyl acetate, butyl acetate, methyl lactate, ethyl lactate, and γ-butyrolactone; carbonates such as ethylene carbonate and propylene carbonate; polyhydric alcohol alkyl ethers such as ethylene glycol monomethyl ether, ethylene glycol monoethyl ether, ethylene glycol monobutyl ether, ethylene glycol dimethyl ether, ethylene glycol diethyl ether, propylene glycol monomethyl ether, propylene glycol monoethyl ether, propylene glycol dimethyl ether, propylene glycol diethyl ether, diethylene glycol monomethyl ether, diethylene glycol monoethyl ether, diethylene glycol monobutyl ether, diethylene glycol dimethyl ether, and diethylene glycol diethyl ether; polyhydric alcohol alkyl ether acetates such as ethylene glycol monomethyl ether acetate, ethylene glycol monoethyl ether acetate, ethylene glycol monobutyl ether acetate, propylene glycol monomethyl ether acetate, propylene glycol monoethyl ether acetate, diethylene glycol monomethyl ether acetate, and diethylene glycol monoethyl ether acetate; and amides such as N,N-dimethylformamide, N,N-dimethylacetamide, and N-methylpyrrolidone.

These organic solvents can be used alone or in combination of two or more thereof.

Optionally, the alkali-soluble (meth)acrylic polymer (A) may further include an ethylenically unsaturated group in the side chain. The composition of such polymer and the method for synthesizing such polymer are not particularly restricted, and, for example, the ethylenically unsaturated group can be introduced into the side chain by subjecting the (meth)acrylic polymer (A) as described above to an addition reaction with a compound having at least one ethylenically unsaturated group and one functional group such as an epoxy group, an oxetanyl group, an isocyanate group, a hydroxyl group, and a carboxyl group.

Examples of the compounds include, but are not limited to, compounds having an ethylenically unsaturated group and an epoxy group such as glycidyl (meth)acrylate, α-ethyl glycidyl (meth)acrylate, α-propyl glycidyl (meth)acrylate, α-butyl glycidyl (meth)acrylate, 2-methyl glycidyl (meth)acrylate, 2-ethyl glycidyl (meth)acrylate, 2-propyl glycidyl (meth)acrylate, 3,4-epoxybutyl (meth)acrylate, 3,4-epoxyheptyl (meth)acrylate, α-ethyl-6,7-epoxyheptyl (meth)acrylate, 3,4-epoxycyclohexylmethyl (meth)acrylate, o-vinylbenzyl glycidyl ether, m-vinylbenzyl glycidyl ether, and p-vinylbenzyl glycidyl ether; compounds having an ethylenically unsaturated group and an oxetanyl group such as (2-ethyl-2-oxetanyl)methyl (meth)acrylate, (2-methyl-2-oxetanyl)methyl (meth)acrylate, 2-(2-ethyl-2-oxetanyl)ethyl (meth)acrylate, 2-(2-methyl-2-oxetanyl)ethyl (meth)acrylate, 3-(2-ethyl-2-oxetanyl)propyl (meth)acrylate, and 3-(2-methyl-2-oxetanyl)propyl (meth)acrylate; compounds having an ethylenically unsaturated group and an isocyanate group such as 2-(meth)acryloyloxyethyl isocyanate; compounds having an ethylenically unsaturated group and a hydroxyl group such as 2-hydroxyethyl (meth)acrylate, 2-hydroxypropyl (meth)acrylate, 3-chloro-2-hydroxypropyl (meth)acrylate, and 2-hydroxybutyl (meth)acrylate; and compounds having an ethylenically unsaturated group and a carboxyl group such as (meth)acrylic acid, crotonic acid, cinnamic acid, (2-(meth)acryloyloxyethyl) succinate, 2-phthaloylethyl (meth)acrylate, 2-tetrahydrophthaloylethyl (meth)acrylate, 2-hexahydrophthaloylethyl (meth)acrylate, ω-carboxy-polycaprolactone mono(meth)acrylate, 3-vinylbenzoic acid, and 4-vinylbenzoic acid.

Among them, glycidyl (meth)acrylate, 3,4-epoxycyclohexylmethyl (meth)acrylate, isocyanate ethyl (meth)acrylate, 2-hydroxyethyl (meth)acrylate, 2-hydroxypropyl (meth)acrylate, 2-hydroxybutyl (meth)acrylate, (meth)acrylic acid, crotonic acid, and 2-hexahydrophthaloylethyl (meth)acrylate are preferred from the standpoint of transparency and reactivity. These compounds can be used alone or in combination of two or more thereof.

Preferably, the alkali-soluble polymer (A) has a weight average molecular weight of from 1,000 to 3,000,000. If the alkali-soluble polymer (A) having a large weight average molecular weight equal to or more than 1,000 is used for a resin composition, the cured composition has sufficient strength. If the alkali-soluble polymer (A) has a weight average molecular weight equal to or less than 3,000,000, the polymer (A) has high solubility in a developer that contains an aqueous alkaline solution and high compatibility with the polymerizable compound (B). In view of the foregoing, the alkali-soluble polymer (A) more preferably has a weight average molecular weight of from 3,000 to 2,000,000 and especially preferably from 5,000 to 1,000,000. In the present invention, weight average molecular weights are determined by gel permeation chromatography (GPC) using polystyrene as standards.

An acid number of the alkali-soluble (meth)acrylic polymer (A) can be selected so that the polymer (A) can be developed with various known developers in a step of selectively removing a layer of a photosensitive resin composition by development as described below to form a pattern. For example, if the polymer (A) is developed with an aqueous alkaline solution such as a sodium carbonate, potassium carbonate, tetramethylammonium hydroxide, or triethanolamine solution, the polymer (A) preferably has an acid number of from 20 to 300 mg KOH/g. The polymer (A) having an acid number equal to or more than 20 mg KOH/g is readily developed, while the polymer (A) having an acid number equal to or less than 300 mg KOH/g does not exhibit reduced developer resistance. In view of the foregoing, the polymer (A) more preferably has an acid number of from 30 to 250 mg KOH/g and especially preferably from 40 to 200 mg KOH/g.

If the polymer (A) is developed with an aqueous alkaline solution that contains water or an aqueous alkaline solution and one or more surfactants, the polymer (A) preferably has an acid number of from 10 to 260 mg KOH/g. The polymer (A) having an acid number equal to or more than 10 mg KOH/g is readily developed, while the polymer (A) having an acid number equal to or less than 260 mg KOH/g does not exhibit reduced developer resistance. In view of the foregoing, the polymer (A) more preferably has an acid number of from 20 to 250 mg KOH/g and especially preferably from 30 to 200 mg KOH/g.

Preferably, the component (A) is contained in an amount of from 10 to 85% by mass based on the total amount of the component (A) and the component (B). If the component (A) is contained in an amount equal to or more than 10% by mass, the cured resin composition for forming an optical waveguide has sufficient strength and sufficient flexibility. If the component (A) is contained in an amount equal to or less than 85% by mass, the composition is readily cured, as the component (A) is incorporated into the component (B) during exposure, and thus the composition does not exhibit lack of developer resistance. In view of the foregoing, the component (A) is more preferably contained in an amount equal to or more than 10% by mass, still more preferably equal to or more than 15% by mass, and especially preferably equal to or more than 20% by mass. The upper limit of the amount is more preferably equal to or less than 75% by mass and especially preferably equal to or less than 65% by mass. The amount of from 10 to 65% by mass is especially preferred for reduction of the optical loss.

Now, the component (B) used in the present invention will be described.

Preferably, the polymerizable compound as the component (B) includes a compound having an epoxy group and an ethylenically unsaturated group per molecule.

For example, the polymerizable compound is an epoxy (meth)acrylate obtained by reacting an epoxy resin having a glycidyl group per molecule with a (meth)acrylic compound. Preferably, one equivalent of the epoxy groups is reacted with 0.1 to 0.9 equivalents, more preferably 0.2 to 0.8 equivalents, and especially preferably 0.4 to 0.6 equivalents of the (meth)acrylic compound.

The specific examples include epoxy acrylates from a difunctional phenol glycidyl ether such as bisphenol A epoxy (meth)acrylate, tetrabromobisphenol A epoxy (meth)acrylate, bisphenol F epoxy (meth)acrylate, bisphenol AF epoxy (meth)acrylate, bisphenol AD epoxy (meth)acrylate, biphenyl epoxy (meth)acrylate, naphthalene epoxy (meth)acrylate, and fluorene epoxy (meth)acrylate; epoxy acrylates from a hydrogenated difunctional phenol glycidyl ether such as hydrogenated bisphenol A epoxy (meth)acrylate, hydrogenated bisphenol F epoxy (meth)acrylate, hydrogenated 2,2′-biphenol epoxy (meth)acrylate, and hydrogenated 4,4′-biphenol epoxy (meth)acrylate; epoxy acrylates from a polyfunctional phenol glycidyl ether such as phenol novolac epoxy (meth)acrylate, cresol novolac epoxy (meth)acrylate, dicyclopentadien-phenol epoxy (meth)acrylate, and tetraphenylolethane epoxy (meth)acrylate; epoxy acrylates from a difunctional aliphatic alcohol glycidyl ether such as polyethylene glycol epoxy (meth)acrylate, polypropylene glycol epoxy (meth)acrylate, neopentyl glycol epoxy (meth)acrylate, and 1,6-hexanediol epoxy (meth)acrylate; epoxy acrylates from a difunctional cycloaliphatic alcohol glycidyl ether such as cyclohexanedimethanol epoxy (meth)acrylate and tricyclodecane dimethanol epoxy (meth)acrylate; epoxy acrylates from a polyfunctional aliphatic alcohol glycidyl ether such as trimethylolpropane epoxy (meth)acrylate, sorbitol epoxy (meth)acrylate, and glycerin epoxy (meth)acrylate; epoxy acrylates from a difunctional aromatic glycidyl ester such as phthalic acid diglycidyl ester; and epoxy acrylates from a difunctional cycloaliphatic glycidyl ester such as tetrahydrophthalic acid diglycidyl ester and hexahydrophthalic acid diglycidyl ester.

Among them, epoxy (meth)acrylates that contain an aliphatic ring or an aromatic ring such as bisphenol A epoxy (meth)acrylate, bisphenol F epoxy (meth)acrylate, bisphenol AF epoxy (meth)acrylate, bisphenol AD epoxy (meth)acrylate, biphenyl epoxy (meth)acrylate, naphthalene epoxy (meth)acrylate, fluorene epoxy (meth)acrylate, phenol novolac epoxy (meth)acrylate, cresol novolac epoxy (meth)acrylate, cyclohexanedimethanol epoxy (meth)acrylate, and tricyclodecanedimethanol epoxy (meth)acrylate are preferred from the standpoint of transparency, high refractive index, and heat resistance. Among them, compounds having a bisphenol backbone in its molecule are preferred.

In addition to the compound having an epoxy group and an ethylenically unsaturated group per molecule, the polymerizable compound as the component (B) preferably includes at least one of a compound that includes two or more ethylenically unsaturated groups per molecule and a compound that includes two or more epoxy groups per molecule, from the standpoint of developability and heat resistance.

The composition in the first aspect of the present invention may be free of the compound having an epoxy group and an ethylenically unsaturated group.

Example of the compound having two or more ethylenically unsaturated groups per molecule include (meth)acrylates, vinylidene halides, vinyl ethers, vinyl esters, vinyl pyridine, vinyl amide, and arylated vinyl. Among them, (meth)acrylates and arylated vinyl are preferred from the standpoint of transparency. Any (meth)acrylate such as a difunctional or polyfunctional (meth)acrylate may be used.

Examples of the difunctional (meth)acrylate include aliphatic (meth)acrylates such as ethylene glycol di(meth)acrylate, diethylene glycol di(meth)acrylate, triethylene glycol di(meth)acrylate, tetraethylene glycol di(meth)acrylate, polyethylene glycol di(meth)acrylate, propylene glycol di(meth)acrylate, dipropylene glycol di(meth)acrylate, tripropylene glycol di(meth)acrylate, tetrapropylene glycol di(meth)acrylate, polypropylene glycol di(meth)acrylate, ethoxylated polypropylene glycol di(meth)acrylate, 1,3-butanediol di(meth)acrylate, 1,4-butanediol di(meth)acrylate, neopentyl glycol di(meth)acrylate, 3-methyl-1,5-pentanediol di(meth)acrylate, 1,6-hexanediol di(meth)acrylate, 2-butyl-2-ethyl-1,3-propanediol di(meth)acrylate, 1,9-nonanediol di(meth)acrylate, 1,10-decanediol di(meth)acrylate, glycerin di(meth)acrylate, tricyclodecanedimethanol (meth)acrylate, and ethoxylated 2-methyl-1,3-propanediol di(meth)acrylate; cycloaliphatic (meth)acrylates such as cyclohexanedimethanol (meth)acrylate, ethoxylated cyclohexanedimethanol (meth)acrylate, propoxylated cyclohexanedimethanol (meth)acrylate, ethoxylated propoxylated cyclohexanedimethanol (meth)acrylate, tricyclodecanedimethanol (meth)acrylate, ethoxylated tricyclodecanedimethanol (meth)acrylate, propoxylated tricyclodecanedimethanol (meth)acrylate, ethoxylated propoxylated tricyclodecanedimethanol (meth)acrylate, ethoxylated hydrogenated bisphenol A di(meth)acrylate, propoxylated hydrogenated bisphenol A di(meth)acrylate, ethoxylated propoxylated hydrogenated bisphenol A di(meth)acrylate, ethoxylated hydrogenated bisphenol F di(meth)acrylate, propoxylated hydrogenated bisphenol F di(meth)acrylate, and ethoxylated propoxylated hydrogenated bisphenol F di(meth)acrylate; aromatic (meth)acrylates such as ethoxylated bisphenol A di(meth)acrylate, propoxylated bisphenol A di(meth)acrylate, ethoxylated propoxylated bisphenol A di(meth)acrylate, ethoxylated bisphenol F di(meth)acrylate, propoxylated bisphenol F di(meth)acrylate, ethoxylated propoxylated bisphenol F di(meth)acrylate, ethoxylated bisphenol AF di(meth)acrylate, propoxylated bisphenol AF di(meth)acrylate, ethoxylated propoxylated bisphenol AF di(meth)acrylate, ethoxylated fluorene di(meth)acrylate, propoxylated fluorene di(meth)acrylate, and ethoxylated propoxylated fluorene di(meth)acrylate; heterocyclic (meth)acrylates such as ethoxylated isocyanuric acid di(meth)acrylate, propoxylated isocyanuric acid di(meth)acrylate, and ethoxylated propoxylated isocyanuric acid di(meth)acrylate; caprolactone modifications thereof; aliphatic epoxy (meth)acrylates such as neopentyl glycol epoxy (meth)acrylate; cycloaliphatic epoxy (meth)acrylates such as cyclohexanedimethanol epoxy (meth)acrylate, hydrogenated bisphenol A epoxy (meth)acrylate, and hydrogenated bisphenol F epoxy (meth)acrylate; and aromatic epoxy (meth)acrylates such as resorcinol epoxy (meth)acrylate, bisphenol A epoxy (meth)acrylate, bisphenol F epoxy (meth)acrylate, bisphenol AF epoxy (meth)acrylate, and fluorene epoxy (meth)acrylate.

Among them, the cycloaliphatic (meth)acrylates; the aromatic (meth)acrylates; the heterocyclic (meth)acrylates; the cycloaliphatic epoxy (meth)acrylates; and the aromatic epoxy (meth)acrylates are preferred from the standpoint of transparency and heat resistance.

Examples of polyfunctional (meth)acrylates having three or more functional groups include aliphatic (meth)acrylates such as trimethylolpropane tri(meth)acrylate, ethoxylated trimethylolpropane tri(meth)acrylate, propoxylated trimethylolpropane tri(meth)acrylate, ethoxylated propoxylated trimethylolpropane tri(meth)acrylate, pentaerythritol tri(meth)acrylate, ethoxylated pentaerythritol tri(meth)acrylate, propoxylated pentaerythritol tri(meth)acrylate, ethoxylated propoxylated pentaerythritol tri(meth)acrylate, pentaerythritol tetra(meth)acrylate, ethoxylated pentaerythritol tetra(meth)acrylate, propoxylated pentaerythritol tetra(meth)acrylate, ethoxylated propoxylated pentaerythritol tetra(meth)acrylate, ditrimethylolpropane tetraacrylate, and dipentaerythritol hexa(meth)acrylate; heterocyclic (meth)acrylates such as ethoxylated isocyanuric acid tri(meth)acrylate, propoxylated isocyanuric acid tri(meth)acrylate, and ethoxylated propoxylated isocyanuric acid tri(meth)acrylate; caprolactone modifications thereof; and aromatic epoxy (meth)acrylates such as phenol novolac epoxy (meth)acrylate and cresol novolac epoxy (meth)acrylate.

Among them, heterocyclic (meth)acrylates and aromatic epoxy (meth)acrylates are preferred from the standpoint of transparency and heat resistance.

These compounds can be used alone or in combination of two or more thereof and can be used in combination with another polymerizable compound.

If the compound having an ethylenically unsaturated group is used, the compound is preferably contained in an amount of from 10 to 90 parts by mass, more preferably from 30 to 80 parts by mass, and especially preferably from 40 to 70 parts by mass based on 100 parts by mass of the total amount of the polymerizable compound as the component (B).

If the compound that includes two or more epoxy groups per molecule is included, the so-called epoxy carboxylation reaction takes place between the compound and a carboxyl group from the alkali-soluble (meth)acrylic polymer as the component (A), and crosslinking occurs, which provides improved heat resistance and improved strength. The compound may be difunctional or polyfunctional.

The specific examples include difunctional phenol glycidyl ethers such as bisphenol A epoxy resins, tetrabromobisphenol A epoxy resins, bisphenol F epoxy resins, bisphenol AF epoxy resins, bisphenol AD epoxy resins, biphenyl epoxy resins, naphthalene epoxy resins, and fluorene epoxy resins; hydrogenated difunctional phenol glycidyl ethers such as hydrogenated bisphenol A epoxy resins, hydrogenated bisphenol F epoxy resins, hydrogenated 2,2′-biphenol epoxy resins, and hydrogenated 4,4′-biphenol epoxy resins; polyfunctional phenol glycidyl ethers such as phenol novolac epoxy resins, cresol novolac epoxy resins, dicyclopentadiene-phenol epoxy resins, and tetraphenylolethane epoxy resins; difunctional aliphatic alcohol glycidyl ethers such as polyethylene glycol epoxy resins, polypropylene glycol epoxy resins, neopentyl glycol epoxy resins, and 1,6-hexanediol epoxy resins; difunctional cycloaliphatic alcohol glycidyl ethers such as cyclohexanedimethanol epoxy resins and tricyclodecanedimethanol epoxy resins; polyfunctional aliphatic alcohol glycidyl ethers such as trimethylolpropane epoxy resins, sorbitol epoxy resins, and glycerin epoxy resins; difunctional aromatic glycidyl esters such as phthalic acid diglycidyl ester; difunctional cycloaliphatic glycidyl esters such as tetrahydrophthalic acid diglycidyl ester and hexahydrophthalic acid diglycidyl ester; difunctional aromatic glycidyl amines such as N,N-diglycidyl aniline and N,N-diglycidyl trifluoromethyl aniline; polyfunctional aromatic glycidylamines such as N,N,N′,N′-tetraglycidyl-4,4-diaminodiphenylmethane, 1,3-bis(N,N-glycidyl aminomethyl)cyclohexane, and N,N,O-triglycidyl-p-aminophenol; difunctional cycloaliphatic epoxy resins such as alicyclic diepoxyacetal, alicyclic diepoxyadipate, alicyclic diepoxycarboxylate, and vinylcyclohexene dioxide; polyfunctional cycloaliphatic epoxy resins such as adducts of 2,2-bis(hydroxymethyl)-1-butanol and 1,2-epoxy-4-(2-oxiranyl)cyclohexane; polyfunctional heterocyclic epoxy resins such as triglycidyl isocyanurate; and difunctional and polyfunctional silicon-containing epoxy resins such as organopolysiloxane epoxy resins.

Among them, difunctional phenol glycidyl ethers such as bisphenol A epoxy resins, bisphenol F epoxy resins, bisphenol AF epoxy resins, bisphenol AD epoxy resins, biphenyl epoxy resins, and naphthalene epoxy resins, and fluorene epoxy resins; the hydrogenated difunctional phenol glycidyl ethers; the polyfunctional phenol glycidyl ethers; the difunctional cycloaliphatic alcohol glycidyl ethers; the difunctional aromatic glycidyl esters; the difunctional cycloaliphatic glycidyl esters; the difunctional cycloaliphatic epoxy resins; the polyfunctional cycloaliphatic epoxy resins; the polyfunctional heterocyclic epoxy resins; the difunctional and polyfunctional silicon-containing epoxy resins are preferred from the standpoint of transparency and heat resistance.

These compounds can be used alone or in combination of two or more thereof and can be used in combination with another polymerizable compound.

In addition to the above compounds, the polymerizable compound as the component (B) preferably further includes one or more compounds that include at least one selected from the group consisting of an alicyclic structure, an aryl group, an aryloxy group, and an aralkyl group, and an ethylenically unsaturated group per molecule, from the standpoint of heat resistance. The specific examples include (meth)acrylates and N-vinyl carbazoles that include at least one selected from the group consisting of an alicyclic structure, an aryl group, an aryloxy group, and an aralkyl group. The term aryl group refers to an aromatic hydrocarbon group such as, for example, a phenyl group or a naphthyl group, or an aromatic heterocyclic group such as a carbazole group.

The composition in the the first and second aspects of the present invention can be free of the compound having an epoxy group and an ethylenically unsaturated group and can include the above compound.

More particularly, the polymerizable compound as the component (B) preferably includes at least one of compounds represented by following general formulas (5) to (8). In a preferred aspect, the polymerizable compound as the component (B) includes at least one of compounds that include an aryl group and an ethylenically unsaturated group as represented by the following general formulas (5) to (8).

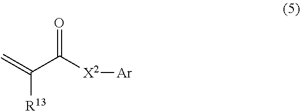

(In the formula, Ar represents any one of following groups:

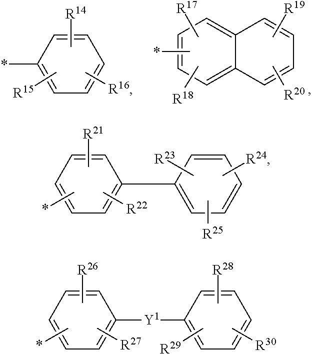

X² represents a divalent group of O (an oxygen atom), S (a sulfur atom), OCH₂, SCH₂, O(CH₂CH₂O)a, O[CH₂CH(CH₃)O]b, or OCH₂CH(OH)CH₂O;

Y¹ represents any one of following divalent groups:

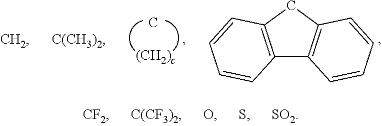

(wherein linkages are on the left and right sides of each of the structures); R¹³ represents a hydrogen atom or a methyl group; R¹⁴ to R³⁰ each independently represent a hydrogen atom, a fluorine atom, an organic group having from 1 to 20 carbon atoms, or a fluorine-containing organic group having from 1 to 20 carbon atoms; a and b each independently represent an integer of from 1 to 20; and c represents an integer of from 2 to 10.)

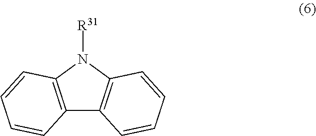

(In the formula, R³¹ represents any one of groups represented by following formulas:

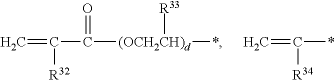

wherein R³² to R³⁴ each independently represent a hydrogen atom or a methyl group, and d represents an integer of from 1 to 10.)

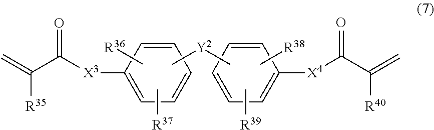

(In the formula, X³ and X⁴ each independently represent a divalent group of O, S, O(CH₂CH₂O)e, or O[CH₂CH(CH₃)O]f;

Y² represents any one of divalent groups represented by following formulas:

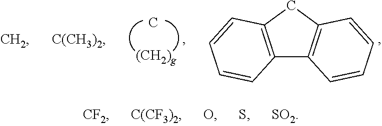

(wherein linkages are on the left and right sides of each of the structures);

R³⁵ and R⁴⁰ each independently represent a hydrogen atom or a methyl group; R³⁶ to R³⁹ each independently represent a hydrogen atom, a fluorine atom, an organic group having from 1 to 20 carbon atoms, or a fluorine-containing organic group having from 1 to 20 carbon atoms; e and f each independently represent an integer of from 1 to 20; and g represents an integer of from 2 to 10.)

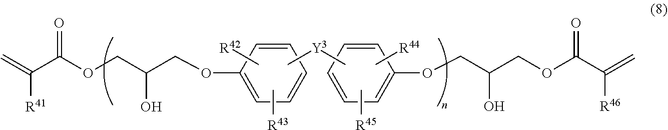

(In the formula, Y³ represents any one of divalent groups represented by following formulas:

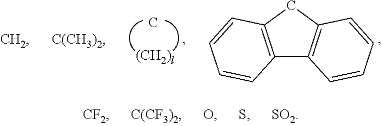

(wherein linkages are on the left and right sides of each of the structures); R⁴¹ and R⁴⁶ each independently represent a hydrogen atom or a methyl group; R⁴² to R⁴⁵ each independently represent a hydrogen atom, a fluorine atom, an organic group having from 1 to 20 carbon atoms, or a fluorine-containing organic group having from 1 to 20 carbon atoms; h represents an integer of from 1 to 5; and i represents an integer of from 2 to 10.)

Examples of the organic groups in the general formulas (5) to (8) include groups similar to the groups described for the general formulas (1) to (4).

Preferably, the polymerizable compound as the component (B) is contained in an amount of from 15 to 90% by mass based on the total amount of the component (A) and the component (B). If the polymerizable compound is contained in an amount equal to or more than 15% by mass, the polymerizable compound readily incorporates the alkali-soluble (meth)acrylic polymer (A) during curing, and thus the cured film does not exhibit lack of developer resistance. If the polymerizable compound is contained in an amount equal to or less than 90% by mass, the cured film has sufficient strength and sufficient flexibility. From the standpoint of the foregoing, the polymerizable compound is more preferably contained in an amount of from 30 to 80% by mass.

Now, the component (C) used in the present invention will be described.

The polymerization initiator as the component (C) is not particularly restricted as long as the initiator initiates polymerization upon heating or irradiation with radiation such as UV radiation. For example, if the polymerizable compound as the component (B) includes a compound having an ethylenically unsaturated group, examples of the initiator include thermal radical polymerization initiators and radical photopolymerization initiators. The radical photopolymerization initiators are preferred from the standpoint of their high cure speed and cold curability.

Examples of the thermal radical polymerization initiators include ketone peroxides such as methyl ethyl ketone peroxide, cyclohexanone peroxide, and methylcyclohexanone peroxide; peroxyketals such as 1,1-bis(t-butylperoxy)cyclohexane, 1,1-bis(t-butylperoxy)-2-methylcyclohexane, 1,1-bis(t-butylperoxy)-3,3,5-trimethylcyclohexane, 1,1-bis(t-hexylperoxy)cyclohexane, and 1,1-bis(t-hexylperoxy)-3,3,5-trimethylcyclohexane; hydroperoxides such as p-menthane hydroperoxide; dialkyl peroxides such as α,α′-bis(t-butylperoxy)diisopropylbenzene, dicumyl peroxide, t-butyl cumyl peroxide, and di-t-butyl peroxide; diacyl peroxides such as octanoyl peroxide, lauroyl peroxide, stearyl peroxide, and benzoyl peroxide; peroxy carbonates such as bis(4-t-butyl cyclohexyl)peroxy dicarbonate, di-2-ethoxyethyl peroxy dicarbonate, di-2-ethylhexyl peroxy dicarbonate, and di-3-methoxybutyl peroxy carbonate; peroxy esters such as t-butylperoxy pivalate, t-hexylperoxy pivalate, 1,1,3,3-tetramethylbutylperoxy-2-ethyl hexanoate, 2,5-dimethyl-2,5-bis(2-ethylhexanoylperoxy)hexane, t-hexylperoxy-2-ethyl hexanoate, t-butylperoxy-2-ethyl hexanoate, t-butylperoxy isobutyrate, t-hexylperoxy isopropyl monocarbonate, t-butylperoxy-3,5,5-trimethyl hexanoate, t-butylperoxy laurate, t-butylperoxy isopropyl monocarbonate, t-butylperoxy-2-ethylhexyl monocarbonate, t-butylperoxy benzoate, t-hexylperoxy benzoate, 2,5-dimethyl-2,5-bis(benzoylperoxy)hexane, and t-butylperoxy acetate; and azo compounds such as 2,2′-azobisisobutylonitrile, 2,2′-azobis(2,4-dimethylvaleronitrile), and 2,2′-azobis(4-methoxy-2′-dimethylvaleronitrile).

Among them, the diacyl peroxides; the peroxy esters; and the azo compounds are preferred from the standpoint of curability, transparency, and heat resistance.

Examples of the radical photopolymerization initiators include benzoin ketals such as 2,2-dimethoxy-1,2-diphenylethan-1-one; α-hydroxy ketones such as 1-hydroxycyclohexylphenyl ketone, 2-hydroxy-2-methyl-1-phenylpropan-1-one, and 1-[4-(2-hydroxyethoxy)phenyl]-2-hydroxy-2-methyl-1-propan-1-one; α-amino ketones such as 2-benzyl-2-dimethylamino-1-(4-morpholinophenyl)-butan-1-one, and 1,2-methyl-1-[4-(methylthio)phenyl]-2-morpholinopropan-1-one; oxime esters such as 1-[(4-phenylthio)phenyl]-1,2-octadion-2-(benzoyl)oxime; phosphine oxides such as bis(2,4,6-trimethylbenzoyl)phenyl phosphine oxide, bis(2,6-dimethoxybenzoyl)-2,4,4-trimethylpentyl phosphine oxide, and 2,4,6-trimethylbenzoyl diphenylphosphine oxide; 2,4,5-triaryl imidazole dimers such as 2-(o-chlorophenyl)-4,5-diphenylimidazole dimer, 2-(o-chlorophenyl)-4,5-di(methoxyphenyl)imidazole dimer, 2-(o-fluorophenyl)-4,5-diphenylimidazole dimer, 2-(o-methoxyphenyl)-4, 5-diphenylimidazole dimer, and 2-(p-methoxyphenyl)-4,5-diphenylimidazole dimer; benzophenone compounds such as benzophenone, N,N′-tetramethyl-4,4′-diaminobenzophenone, N,N′-tetraethyl-4,4′-diaminobenzophenone, and 4-methoxy-4′-dimethylaminobenzophenone; quinone compounds such as 2-ethylanthraquinone, phenanthrenequinone, 2-tert-butylanthraquinone, octamethylanthraquinone, 1,2-benzanthraquinone, 2,3-benzanthraquinone, 2-phenylanthraquinone, 2,3-diphenylanthraquinone, 1-chloroanthraquinone, 2-methylanthraquinone, 1,4-naphthoquinone, 9,10-phenanthraquinone, 2-methyl-1,4-naphthoquinone, and 2,3-dimethylanthraquinone; benzoin ethers such as benzoin methyl ether, benzoin ethyl ether, and benzoin phenyl ether; benzoin compounds such as benzoin, methylbenzoin, and ethylbenzoin; benzyl compounds such as benzyl dimethyl ketal; acridine compounds such as 9-phenylacridine and 1,7-bis(9,9′-acridinyl heptane); N-phenylglycine, and coumalin.

In the 2,4,5-triarylimidazole dimer, the aryl substituents in the two triarylimidazole moieties may provide identical and symmetrical compounds or different and asymmetrical compounds. And a thioxanthone compound and a tertiary amine may be combined, including a combination of diethylthioxanthone and dimethylaminobenzoic acid.

Among them, the α-hydroxy ketones and the phosphine oxides are preferred from the standpoint of curability, transparency, and heat resistance. These thermal and radical photopolymerization initiators can be used alone or in combination of two or more thereof and can also be used in combination with an appropriate photosensitizer.

If the polymerizable compound as the component (B) is an epoxy resin, examples of the polymerization initiator as the component (C) include thermal cationic polymerization initiators and cationic photopolymerization initiators. The cationic photopolymerization initiators are preferred from the standpoint of their high cure speed and cold curability.

Examples of the thermal cationic polymerization initiators include benzylsulfonium salts such as p-alkoxyphenyl benzyl methyl sulfonium hexafluoroantimonate; pyridinium salts such as benzyl-p-cyanopyridinium hexafluoroantimonate, 1-naphthylmethyl-o-cyanopyridinium hexafluoroantimonate, and cinnamyl-o-cyanopyridinium hexafluoroantimonate; and benzyl ammonium salts such as benzyl dimethyl phenyl ammonium hexafluoroantimonate.

Among them, the benzyl sulfonium salts are preferred from the standpoint of curability, transparency, and heat resistance.

Examples of the cationic photopolymerization initiators include aryl diazonium salts such as p-methoxybenzene diazonium hexafluorophosphate; diaryl iodonium salts such as diphenyliodonium hexafluorophosphate and diphenyliodonium hexafluoroantimonate; triaryl sulfonium salts such as triphenylsulfonium hexafluorophosphate, triphenylsulfonium hexafluoroantimonate, diphenyl-4-thiophenoxyphenylsulfonium hexafluorophosphate, diphenyl-4-thiophenoxyphenylsulfonium hexafluoroantimonate, and diphenyl-4-thiophenoxyphenylsulfonium pentafluorohydroxyantimonate; triaryl selenonium salts such as triphenylselenonium hexafluorophosphate, triphenylselenonium tetrafluoroborate and triphenylselenonium hexafluoroantimonate; dialkyl phenacylsulfonium salts such as dimethyl phenacylsulfonium hexafluoroantimonate and diethyl phenacylsulfonium hexafluoroantimonate; dialkyl-4-hydroxy salts such as 4-hydroxyphenyl dimethyl sulfonium hexafluoroantimonate and 4-hydroxyphenyl benzyl methyl sulfonium hexafluoroantimonate; and sulfonic acid esters such as α-hydroxymethyl benzoin sulfonic acid ester, N-hydroxy imide sulfonate, α-sulfonyloxy ketone, and β-sulfonyloxy ketone.

Among them, the triaryl sulfonium salts are preferred from the standpoint of curability, transparency, and heat resistance. These thermal cationic polymerization and cationic photopolymerization initiators can be used alone or in combination of two or more thereof and can also be used in combination with an appropriate photosensitizer.

Preferably, the polymerization initiator as the component (C) is contained in an amount of from 0.1 to 10 parts by mass based on 100 parts by mass of the total amount of the component (A) and the component (B). If the polymerization initiator is contained in an amount equal to or more than 0.1 parts by mass, the composition is sufficiently cured. If the polymerization initiator is contained in an amount equal to or less than 10 parts by mass, the resultant composition has sufficient light transmission. In view of the foregoing, the polymerization initiator is more preferably contained in an amount of from 0.3 to 7 parts by mass and especially preferably from 0.5 to 5 parts by mass.

The resin composition for forming an optical waveguide according to the present invention may also optionally include a so-called additive such as an antioxidant, an anti-yellowing agent, a UV light absorber, a visible light absorber, a colorant, a plasticizer, a stabilizer, or a filler in an amount that does not impair an effect of the present invention.

Now, the resin composition for forming an optical waveguide according to the present invention will be described.

The resin composition for forming an optical waveguide according to the present invention may be diluted with a suitable organic solvent, for use as a resin varnish for forming an optical waveguide. The organic solvent is not particularly restricted as long as the solvent can dissolve the resin composition. Examples of the solvent include aromatic hydrocarbons such as toluene, xylene, mesitylene, cumene, and p-cymene; cyclic ethers such as tetrahydrofuran and 1,4-dioxane; alcohols such as methanol, ethanol, isopropanol, butanol, ethylene glycol, and propylene glycol; ketones such as acetone, methyl ethyl ketone, methyl isobutyl ketone, cyclohexanone, and 4-hydroxy-4-methyl-2-pentanone; esters such as methyl acetate, ethyl acetate, butyl acetate, methyl lactate, ethyl lactate, and γ-butyrolactone; carbonates such as ethylene carbonate and propylene carbonate; polyhydric alcohol alkyl ethers such as ethylene glycol monomethyl ether, ethylene glycol monoethyl ether, ethylene glycol monobutyl ether, ethylene glycol dimethyl ether, ethylene glycol diethyl ether, propylene glycol monomethyl ether, propylene glycol monoethyl ether, propylene glycol dimethyl ether, propylene glycol diethyl ether, diethylene glycol monomethyl ether, diethylene glycol monoethyl ether, diethylene glycol monobutyl ether, diethylene glycol dimethyl ether, and diethylene glycol diethyl ether; polyhydric alcohol alkyl ether acetates such as ethylene glycol monomethyl ether acetate, ethylene glycol monoethyl ether acetate, ethylene glycol monobutyl ether acetate, propylene glycol monomethyl ether acetate, propylene glycol monoethyl ether acetate, diethylene glycol monomethyl ether acetate, and diethylene glycol monoethyl ether acetate; and amides such as N,N-dimethylformamide, N,N-dimethylacetamide, and N-methylpyrrolidone.

Among them, toluene, methanol, ethanol, isopropanol, acetone, methyl ethyl ketone, methyl isobutyl ketone, cyclohexanone, methyl acetate, ethyl acetate, butyl acetate, methyl lactate, ethyl lactate, ethylene glycol monomethyl ether, ethylene glycol monoethyl ether, propylene glycol monomethyl ether, propylene glycol monoethyl ether, diethylene glycol dimethyl ether, ethylene glycol monomethyl ether acetate, propylene glycol monomethyl ether acetate, and N,N-dimethylacetamide are preferred from the standpoint of their dissolubility and boiling point.

These organic solvents can be used alone or in combination of two or more thereof. In general, the resin varnish preferably has a solid content of from 20 to 80% by mass.

Preferably, the resin varnish for forming an optical waveguide is prepared by combining the resin composition and the solvent with stirring. The stirring method is not particularly restricted, and the stirring is preferably achieved using a propeller from the standpoint of stirring efficiency. During stirring, the propeller may be rotated at any suitable rate and preferably at a rate of from 10 to 1,000 rpm. If the propeller is rotated at a rate equal to or more than 10 rpm, the components (A) to (C) and the organic solvent are sufficiently mixed. If the propeller is rotated at a rate equal to or less than 1,000 rpm, entrainment of bubbles due to rotation of the propeller is reduced. In view of the foregoing, the propeller is more preferably rotated at a rate of from 50 to 800 rpm and especially preferably from 100 to 500 rpm. The stirring period is not particularly restricted and preferably in the range of from 1 to 24 hours. If the stirring period is an hour, the components (A) to (C) and the organic solvent are sufficiently mixed. If the stirring period is equal to or less than 24 hours, the time to prepare the varnish can be reduced.

Preferably, the prepared resin varnish for forming an optical waveguide is filtered through a filter having a pore size equal to or less than 50 μm. If the pore size is equal to or less than 50 μm, large foreign materials, for example, are removed. Then, no crawling, for example, is exhibited during application of the varnish, and scattering of light travelling through the core array is prevented. In view of the foregoing, the varnish is more preferably filtered through a filter having a pore size equal to or less than 30 μm and especially preferably a filter having a pore size equal to or less than 10 μm.

Preferably, the prepared resin varnish for forming an optical waveguide is degassed under reduced pressure. The degassing method is not particularly restricted. Specific examples of the method can include use of a vacuum pump and bell jar and use of a degasser equipped with a vacuum device. The reduced pressure is not particularly restricted and is preferably a pressure at which the organic solvent in the resin varnish does not boil. The degassing period is not particularly restricted and is preferably in the range of from 3 to 60 minutes. If the degassing period is equal to or more than 3 minutes, babbles dissolved in the resin varnish can be removed. If the degassing period is equal to or less than 60 minutes, the organic solvent in the resin varnish does not volatilize.

Preferably, a cured film that is formed by polymerizing and curing the resin composition for forming an optical waveguide that includes the polymer (A), the polymerizable compound (B), and the polymerization initiator (C) according to the present invention has a refractive index in the range of from 1.400 to 1.700 at a temperature of 25° C. and a wavelength in the range of from 830 to 850 nm. The film having a refractive index of from 1.400 to 1.700 maintains versatility as an optical material, as the film has a refractive index that is similar to the index of common optical resin films. In view of the foregoing, the film more preferably has a refractive index of from 1.425 to 1.675 and especially preferably of from 1.450 to 1.650.

Preferably, a cured film that has a thickness of 50 μm and that is formed by polymerizing and curing the resin composition for forming an optical waveguide according to the present invention, the composition including the polymer (A), the polymerizable compound (B), and the polymerization initiator (C), has a transmission equal to or more than 80% at a wavelength of 400 nm. The film having a transmission equal to or more than 80% transmits a sufficient amount of light. In view of the foregoing, the film more preferably has a transmission equal to or more than 85%. The upper limit of the transmission is not particularly restricted.

Now, the resin film for forming an optical waveguide according to the present invention will be described.

The resin film for forming an optical waveguide according to the present invention is formed from the resin composition for forming an optical waveguide as described above. The resin film can be readily produced by applying the resin varnish for forming an optical waveguide, the varnish including the components (A) to (C), to a suitable substrate film and removing the solvent. Alternatively, the resin film may be produced by directly applying the resin composition for forming an optical waveguide to a substrate film.

Examples of the substrate film include, but are not limited to, films of polyesters such as polyethylene terephthalates, polybutylene terephthalates, and polyethylene naphthalates, polyolefins such as polyethylenes and polypropylenes, polycarbonates, polyamides, polyimides, polyamideimides, polyetherimides, polyether sulfides, polyether sulfones, polyether ketones, polyphenylene ethers, polyphenylene sulfides, polyarylates, polysulfones, and liquid crystalline polymers. Among them, films of polyethylene terephthalates, polybutylene terephthalates, polyethylene naphthalates, polypropylenes, polycarbonates, polyamides, polyimides, polyamideimides, polyphenylene ethers, polyphenylene sulfides, polyarylates, and polysulfones are preferred from the standpoint of flexibility and toughness.

The thickness of the substrate film may vary depending on desired flexibility and is preferably in the range of from 3 to 250 μm. The substrate film having a thickness equal to or more than 3 μm has a sufficient film strength, while the substrate film having a thickness equal to or less than 250 μm has a sufficient flexibility. In view of the foregoing, the substrate film more preferably has a thickness of from 5 to 200 μm and especially preferably from 7 to 150 μm. To improve releasability from the resin layer, the substrate film may optionally be treated with a release agent such as a silicone compound or a fluorine-containing compound.

After the resin film for forming an optical waveguide is produced by applying the resin varnish for forming an optical waveguide or the resin composition for forming an optical waveguide to the substrate film, a protective film may be optionally applied to the resin layer to form a three-layered structure that includes the substrate film, the resin layer, and the protective film.

Examples of the material of the protective film include, but are not limited to, polyesters such as polyethylene terephthalates, polybutylene terephthalates, and polyethylene naphthalates and polyolefins such as polyethylenes and polypropylenes. Among them, polyesters such as polyethylene terephthalates and polyolefins such as polyethylenes and polypropylenes are preferred from the standpoint of flexibility and toughness. To improve releasability from the resin layer, the protective film may optionally be treated with a release agent such as a silicone compound or a fluorine-containing compound. The cover film may have any suitable thickness depending on desired flexibility and preferably has a thickness of from 10 to 250 μm. The cover film having a thickness equal to or more than 10 μm has sufficient film strength, while the cover film having a thickness equal to or less than 250 μm has sufficient flexibility. In view of the foregoing, the cover film more preferably has a thickness of from 15 to 200 μm and especially preferably from 20 to 150 μm.

The thickness of the resin film for forming an optical waveguide according to the present invention is not particularly restricted, and usually, the resin film preferably has a dried thickness of from 5 to 500 μm. The resin film having a dried thickness equal to or more than 5 μm has a sufficient thickness, and thus the resin film or the cured resin film exhibits sufficient strength. The resin film having a dried thickness equal to or less than 500 μm can be sufficiently dried. Thus, the amount of residual solvents in the resin film is not increased, and the cured resin film does not form a foam while the cured resin film is heated.

The resin film for forming an optical waveguide, the film being obtained in the above manner, can be readily stored, for example, in a roll form. Alternatively, the film in a roll form can be cut into a suitable size and be stored in a sheet form.

The resin composition for forming an optical waveguide according to the present invention is a suitable resin composition for forming an optical waveguide. The resin film for forming an optical waveguide according to the present invention is also a suitable resin film for forming an optical waveguide.

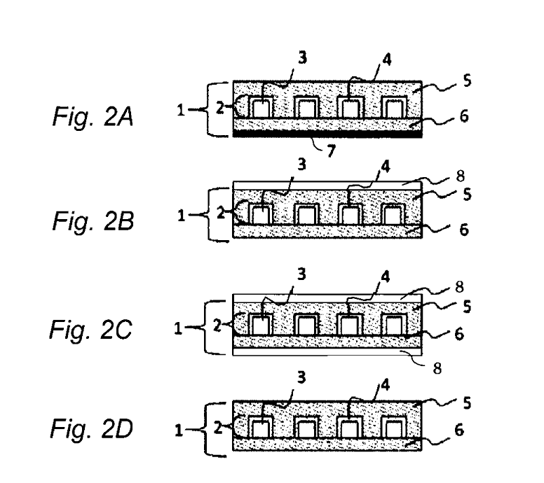

Now, an optical waveguide according to the present invention will be described. FIGS. 2A, 2B, 2C, and 2D are a cross-sectional view illustrating an exemplary construction of an optical waveguide according to the present invention.

As shown in FIG. 2A, an optical waveguide 1 includes a core array 2 that is formed above a substrate 7 and that is formed from a high-refractive-index resin-composition for forming the core array, and a lower cladding layer 6 and an upper cladding layer 5 that are formed from a low-refractive-index resin composition for forming the cladding layers.

Preferably, the resin composition for forming an optical waveguide or the resin film for forming an optical waveguide according to the present invention is used for at least one of the lower cladding layer 6, the core array 2, and the upper cladding layer 5 of the optical waveguide 1. More preferably, the resin composition or the resin film is used for at least the core array 2 from the standpoint of the ability to form a pattern using a developer that contains an aqueous alkaline solution.

Use of the resin film for forming an optical waveguide allows a further increase of adhesion between the cladding layers and the cores and a further improvement in the ability to form a pattern (thin lines or narrow lines) during formation of a core pattern of the optical waveguide, which can provide a fine pattern of thin and narrow lines. Use of the resin film also allows provision of a highly productive process that can produce a large optical waveguide at a time.

The substrate 7 of the optical waveguide 1 can be a hard substrate such as a silicon substrate, a glass substrate, or a glass epoxy substrate such as an FR-4 substrate. Alternatively, a flexible and tough substrate film may be used for the optical waveguide 1 in order to form a flexible optical waveguide.

A flexible and tough substrate film may be also used as a cover film 8 in the optical waveguide 1. Provision of the cover film 8 allows the optical waveguide 1 to take advantage of the flexibility and the toughness of the cover film 8. The cover film 8 also prevents staining and scratching of the optical waveguide 1 and thus provides improved handability.

In view of the foregoing, the cover film 8 may be disposed on the upper cladding layer 5 as shown in FIG. 2B, or the cover film 8 may be disposed on both of the lower cladding layer 6 and the upper cladding layer 5 as shown in FIG. 2C.

When the optical waveguide 1 has sufficient flexibility and sufficient toughness, the cover film 8 need not be necessarily disposed as shown in FIG. 2D.

The thickness of the lower cladding layer 6 is not particularly restricted and is preferably in the range of from 2 to 200 μm. If the lower cladding layer 6 has a thickness equal to or more than 2 μm, it is easy to trap propagated light within the cores. If the lower cladding layer 6 has a thickness equal to or less than 200 μm, the total thickness of the optical waveguide 1 is not too great. As used herein, the thickness of the lower cladding layer 6 refers to the distance between the interface between the core array 2 and the lower cladding layer 6 and the lower surface of the lower cladding layer 6. The thickness of the resin film for forming the lower cladding layer is not particularly restricted and is adjusted so that the cured cladding layer 6 has a thickness in the above range.

The height of the core array 2 is not particularly restricted and is preferably in the range of from 10 to 100 μm. If the core array has a height equal to or more than 10 μm, alignment tolerance is not tight when a formed optical waveguide is connected to a light receiving and emitting element or an optical fiber. If the core array has a height equal to or less than 100 μm, connection efficiency is not decreased when a formed optical waveguide is connected to a light receiving and emitting element or an optical fiber. In view of the foregoing, the core array more preferably has a height of from 15 to 80 μm and especially preferably from 20 to 70 μm. The thickness of the resin film for forming the core array is not particularly restricted and is adjusted so that the cured core array has a thickness in the above range.

The thickness of the upper cladding layer 5 is not particularly restricted as long as the core array 2 can be introduced into the cladding layer 5, and the upper cladding layer 5 preferably has a dried thickness of from 12 to 500 μm. Although the upper cladding layer 5 may have a thickness that is the same as or different from the thickness of the lower cladding layer 6, which is first formed, the upper cladding layer 5 preferably has a thickness that is larger than the thickness of the lower cladding layer 6, considering that the core array 2 is introduced into the upper cladding layer 5. As used herein, the thickness of the upper cladding layer 5 refers to the distance between the interface between the core array 2 and the lower cladding layer 6 and the upper surface of the upper cladding layer 5.

The optical waveguide according to the present invention can exhibit an optical propagation loss equal to or less than 0.25 dB/cm. The optical waveguide can also exhibit an optical propagation loss equal to or less than 0.15 dB/cm and thus exhibits a lower optical loss and transmits a sufficiently strong signal. In view of the foregoing, the optical waveguide can also exhibit an optical propagation loss equal to or less than 0.10 dB/cm.

Now, we will describe the most suitable example of production of an optical waveguide using the resin film for forming an optical waveguide according to the present invention.

A substrate used in production of the resin film for forming the core array is not particularly restricted as long as the substrate transmits actinic radiation for exposure to form a core pattern as described below. Examples of a material of the substrate include polyesters such as polyethylene terephthalates, polybutylene terephthalates, and polyethylene naphthalates; polyolefins such as polyethylenes and polypropylenes; polycarbonates, polyphenylene ethers, and polyarylates.

Among them, polyesters such as polyethylene terephthalates and polybutylene terephthalates and polyolefins such as polypropylenes are preferred from the standpoint of transmission of actinic radiation for exposure, flexibility, and toughness. It is more preferred to use a highly transparent substrate film to improve transmission of actinic radiation for exposure and to reduce roughness of a sidewall of the core pattern. Examples of the highly transparent substrate film include Cosmoshine A1517 and Cosmoshine A4100 from Toyobo Co., Ltd. To improve releasability from the resin layer, the substrate film may optionally be treated with a release agent such as a silicone compound or a fluorine-containing compound.

Preferably, the substrate film for the resin film for forming the core array has a thickness of from 5 to 50 μm. The substrate film having a thickness equal to or more than 5 μm is sufficiently strong as a support. The substrate film having a thickness equal to or less than 50 μm provides a reduced gap between a photomask and a layer of the resin composition for forming the core array during formation of the core pattern, which provides great patternability. In view of the foregoing, the substrate film more preferably has a thickness of from 10 to 40 μm and especially preferably from 15 to 30 μm.

After a resin layer is formed by applying the resin varnish for forming an optical waveguide or the resin composition for forming an optical waveguide to the substrate film, the protective film may be optionally applied to the resin layer to produce a resin film for forming an optical waveguide, the film having a three-layered structure that includes the substrate film, the resin layer, and the protective film.

The resin film for forming an optical waveguide that is obtained in such manner can be readily stored, for example, in a roll form. Alternatively, the film in a roll form can be cut into a suitable size and be stored in a sheet form.

Now, a method for forming the optical waveguide 1 using at least one of the resin composition for forming an optical waveguide and the resin film for forming an optical waveguide will be described.

Examples of a method for producing the optical waveguide 1 according to the present invention include, but are not limited to, spin coating using the resin varnish for forming the core array and the resin composition for forming the cladding layers and laminating using the resin film for forming the core array and the resin film for forming the cladding layers. These methods can be used in combination to produce the optical waveguide 1. Among them, laminating using the resin film for forming an optical waveguide is preferred from the standpoint of the ability to provide a highly productive process for producing the optical waveguide.

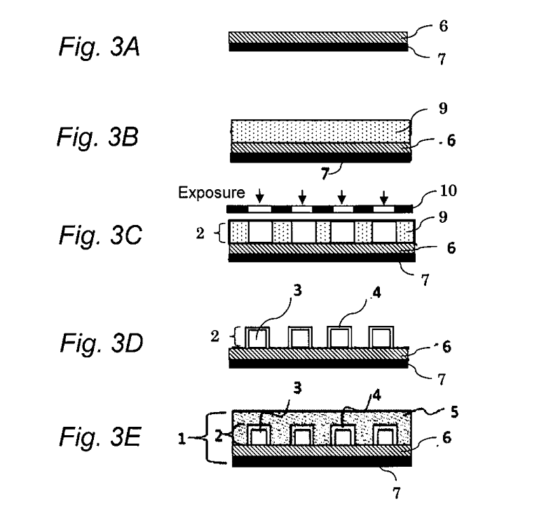

Now, a method for producing the optical waveguide 1 using the resin film for forming an optical waveguide for the lower cladding layer, the core array, and the upper cladding layer will be described with reference to FIGS. 3A, 3B, 3C, 3D, and 3E.

In a first step, the resin film for forming the lower cladding layer is laminated to the substrate 7 to form the lower cladding layer 6, as shown in FIG. 3A. Examples of a method for laminating the film in the first step include a method for laminating the film under heat and pressure using a roll laminator or a plate laminator. From the standpoint of adhesion and conformability, it is preferred to use a plate laminator to laminate, under reduced pressure, the resin film for forming the lower cladding layer. In the present invention, the plate laminator refers to a laminator that laminates materials by disposing the materials between a pair of plates and applying pressure to the plates to bond the materials. For example, it is suitable to use a vacuum pressure laminator. The heating temperature is preferably in the range of from 40 to 130° C., and the bonding pressure is preferably in the range of from 0.1 to 1.0 MPa, although the conditions are not limited to the above respective range. If the resin film for forming the lower cladding layer includes a protective film, the protective film is removed before laminating the film.

Before laminating the film using a vacuum pressure laminator, the resin film for forming the lower cladding layer may be temporarily applied to the substrate 7 using a roll laminator. To improve adhesion and conformability, the resin film is temporarily applied preferably under pressure and may also be applied under pressure and heat using a laminator having a heated roll. Preferably, the laminating temperature is in the range of from 20 to 130° C. The laminating temperature equal to or higher than 20° C. provides enhanced adhesion between the resin film for forming the lower cladding layer 6 and the substrate 7. The laminating temperature equal to or lower than 130° C. prevents the resin layer from excessively flowing during roll laminating, which provides a desired film-thickness. In view of the foregoing, the laminating temperature is more preferably in the range of from 40 to 100° C. The pressure is preferably in the range of from 0.2 to 0.9 MPa, and the laminating rate is preferably in the range of from 0.1 to 3 m/min, although the conditions are not limited to the above respective range.

Then, the resin film for forming the lower cladding layer, the film being laminated to the substrate 7, is cured by at least one of light and heat, and the substrate film is removed from the resin film for forming the lower cladding layer to form the lower cladding layer 6.

In formation of the lower cladding layer 6, the film is preferably exposed to actinic radiation at a dose of from 0.1 to 5 J/cm² and preferably heated at a temperature of from 50 to 200° C., although the conditions are not limited to the above respective range.

Then in a second step, a resin film 9 for forming the core array is laminated in a manner similar to the manner in the first step, as shown in FIG. 3B. Preferably, the resin film 9 for forming the core array is designed to have a higher refractive index than the index of the resin film for forming the lower cladding layer and includes a photosensitive resin composition that can form a core pattern by exposure to actinic radiation.

Then in a third step, the core array is exposed to form a core pattern (core array 2) for the optical waveguide, as shown in FIG. 3C. More particularly, the resin film 9 is imagewise exposed to actinic radiation through a photomask 10 having a negative or positive mask pattern called artwork. Alternatively, the resin film 9 may be directly imagewise exposed to actinic radiation by direct laser writing without the photomask 10. Examples of a source of the actinic radiation include known light sources that effectively emit UV light such as carbon arc lamps, mercury-vapor arc lamps, ultra-high-pressure mercury lamps, and high-pressure mercury lamps, and xenon lamps. Other examples include light sources that effectively emit visible light such as photographic flood lamps and solar powered lamps.

Preferably, the resin film 9 is exposed to actinic radiation at a dose of from 0.01 to 10 J/cm². The exposure at a dose equal to or more than 0.01 J/cm² allows the curing reaction to proceed well and prevents the core array 2 from dissolving out in a development step as described below. The exposure at a dose equal to or less than 10 J/cm² prevents thickening of the core array 2 due to overexposure and thus can suitably form a fine pattern. In view of the foregoing, the resin film 9 is preferably exposed at a dose of from 0.05 to 5 J/cm² and especially preferably from 0.1 to 3 J/cm².

After exposure, the film 9 may be heated to improve resolution and adhesion of the core array 2. Preferably, the time from exposure to UV light to post-exposure heating is within 10 minutes. If the time is within 10 minutes, active species generated by exposure to UV light are not deactivated. Preferably, the post-exposure heating is carried out at a temperature of from 40 to 160° C. for a period of from 30 seconds to 10 minutes.

After exposure, the substrate film is removed from the resin film 9 for forming the core array, and the resin film 9 is developed using a developer that is compatible with the composition of the resin film for forming the core array, such as an aqueous alkaline solution or an aqueous developer by a known method such as, for example, spraying, fluidized bed immersion, brushing, scraping, dipping, or puddle developing, as shown in FIG. 3D. Optionally, two or more developing methods may be combined.

Examples of a base in the aqueous alkaline solution include, but are not limited to, alkali hydroxides such as hydroxides of lithium, sodium, or potassium; alkaline carbonates such as carbonates and bicarbonates of lithium, sodium, potassium, or ammonium; alkali metal phosphates such as potassium phosphate and sodium phosphate; alkali metal pyrophosphates such as sodium pyrophosphate and potassium pyrophosphate; sodium salts such as borax and sodium metasilicate; and organic bases such as tetramethylammonium hydroxide, triethanolamine, ethylene diamine, diethylene triamine, 2-amino-2-hydroxymethyl-1,3-propanediol, and 1,3-diaminopropanol-2-morpholine. Preferably, the aqueous alkaline solution used for development has a pH of from 9 to 11. The temperature of the solution is adjusted to developability of the layer of the resin composition for forming the core array. The aqueous alkaline solution may be admixed with, for example, a surface active agent, a defoamer, a small amount of an organic solvent to facilitate development.

The aqueous developer is not particularly restricted as long as the developer includes water or an aqueous alkaline solution and one or more organic solvents. Preferably, the aqueous developer has a pH that is as low as possible consistent with allowing for satisfactory development of the resin film for forming the core, and preferably has a pH of from 8 to 12 and especially preferably a pH of from 9 to 10.

Examples of the organic solvent include alcohols such as methanol, ethanol, isopropanol, butanol, ethylene glycol, and propylene glycol; ketones such as acetone and 4-hydroxy-4-methyl-2-pentanone; and polyhydric alcohol alkyl ethers such as ethylene glycol monomethyl ether, ethylene glycol monoethyl ether, propylene glycol monomethyl ether, propylene glycol monoethyl ether, diethylene glycol monomethyl ether, diethylene glycol monoethyl ether, and diethylene glycol monobutyl ether.

These solvents can be used alone or in combination of two or more thereof. Generally, the organic solvent preferably has a concentration of from 2 to 90% by mass. The temperature of the solvent is adjusted to developability of the resin composition for forming the core array. The aqueous developer may be admixed with a small amount of, for example, a surfactant and a defoamer.

After development, the core array 2 of the optical waveguide may be optionally washed with washings that contain water and the above organic solvent. The organic solvents may be used alone or in combination of two or more thereof. Generally, the organic solvent preferably has a concentration of from 2 to 90% by mass. The temperature of the solvent is adjusted to developability of the resin composition for forming the core array.

After development or washing, the core array 2 may be optionally cured by heating at a temperature of from about 60 to 250° C. or by exposure at a dose of from about 0.1 to 1000 mJ/cm².

Then, in a fourth step, a resin film for forming the upper cladding layer is laminated in a manner similar to the manner in the first and second steps to form the upper cladding layer 5, as shown in FIG. 3E. The resin film for forming the upper cladding layer is designed to have a refractive index that is lower than the index of the resin film for forming the core array. Preferably, the upper cladding layer 5 has a thickness that is larger than the height of the core array 2.

Then, the resin film for forming the upper cladding layer is cured by at least one of light and heat in a manner similar to the manner in the first step to form the upper cladding layer 5.

If the substrate film of the resin film for forming the cladding layer is a PET film, the resin film is preferably exposed to actinic radiation at a dose of from 0.1 to 5 J/cm². If the substrate film is a film such as a polyethylene naphthalate, polyamide, polyimide, polyamideimide, polyetherimide, polyphenylene ether, polyether sulfide, polyether sulfone, or polysulfone film, the film is more opaque to actinic radiation at short wavelength such as UV light compared with a PET film, and thus the resin film is preferably exposed to actinic radiation at a dose of from 0.5 to 30 J/cm². The exposure at a dose equal to or more than 0.5 J/cm² allows the curing reaction to proceed well, while the exposure at a dose equal to or less than 30 J/cm² prevents excessively long exposure. In view of the foregoing, the resin film is more preferably exposed at a dose of from 3 to 27 J/cm² and especially preferably from 5 to 25 J/cm².

To further cure the resin film, a two-sided exposure device that can simultaneously irradiate both sides of the resin film with actinic radiation can be used. The resin film may be also irradiated with actinic radiation with heating. Preferably, at least one of irradiation with actinic radiation and post-exposure heating may be carried out at a temperature of from 50 to 200° C. Note that the conditions are not a requirement.

After formation of the upper cladding layer 5, the substrate film can be removed, if necessary, to form the optical waveguide 1.

The optical waveguide according to the present invention has high transparency and high ability to propagate light and thus may be used as an optical transmission path of an optical module. Examples of the optical module include optical waveguides having optical fibers connected to both ends of the waveguides; optical waveguides having connectors connected to both ends of the waveguides; opto-electric hybrid boards including an optical waveguide formed in a printed circuit board; opto-electric transducer modules including a combination of an optical waveguide and an opto-electric transducer element that converts optical signals to electric signals and vice versa; and wavelength add/drop devices including a combination of an optical waveguide and a wavelength-division filter. The printed circuit board in the opto-electric hybrid boards is not particularly restricted and may be a rigid substrate such as a glass epoxy substrate or a flexible substrate such as a polyimide substrate.

Now, examples of the present invention will be described more specifically.

### Synthesis Example 1

### Production of Base Polymer for Forming Cladding Layer: (Meth)acrylic Polymer (P-1)

46 parts by mass of propylene glycol monomethyl ether acetate and 23 parts by mass of methyl lactate were weighed into a flask equipped with a stirrer, a condenser, a gas inlet tube, an addition funnel, and a temperature gauge and stirred while nitrogen gas was introduced into the flask. The liquid was heated to 65° C. A mixture of 47 parts by mass of methyl methacrylate, 33 parts by mass of butyl acrylate, 16 parts by mass of 2-hydroxyethyl methacrylate, 14 parts by mass of methacrylic acid, 3 parts by mass of 2,2′-azobis(2,4-dimethylvaleronitrile), 46 parts by mass of propylene glycol monomethyl ether acetate, and 23 parts by mass of methyl lactate was added dropwise over a period of 3 hours and stirred at 65° C. for 3 hours and then at 95° C. for an hour to give a solution of the (meth)acrylic polymer (P-1) (solid content: 45% by mass).

### [Measurement of Acid Number]

The acid number of the P-1 was measured to be 79 mg KOH/g. The acid number was determined as the mass of a 0.1 mol/L aqueous solution of potassium hydroxide that is required to neutralize the P-1 solution. The neutralization point was defined as the point at which phenolphthalein added as an indicator changed in color from colorless to pink.

### [Measurement of Weight Average Molecular Weight]

The weight average molecular weight (relative to polystyrene standards) of the P-1 was measured using GPC (“SD-8022”, “DP-8020”, and “RI-8020” from Tosoh Corp.) and found to be 3.9×10⁴. “Gelpack GL-A150-S” and “Gelpack GL-A160-S” from Hitachi Chemical Co., Ltd. were used as columns. The molecular weight was measured at a sample concentration of 0.5 mg/ml and an elution rate of 1 ml/min using tetrahydrofuran as an eluent.

### Synthesis Example 2

### Production of Base Polymer for Forming Core Layer: (Meth)acrylic Polymer (P-2)

42 parts by mass of propylene glycol monomethyl ether acetate and 21 parts by mass of methyl lactate were weighed into a flask equipped with a stirrer, a condenser, a gas inlet tube, an addition funnel, and a temperature gauge and stirred while nitrogen gas was introduced into the flask. The liquid was heated to 65° C. A mixture of 14.5 parts by mass of N-cyclohexylmaleimide, 20 parts by mass of benzyl acrylate, 39 parts by mass of O-phenylphenol 1.5EO acrylate, 14 parts by mass of 2-hydroxyethyl methacrylate, 12.5 parts by mass of methacrylic acid, 4 parts by mass of 2,2′-azobis(2,4-dimethylvaleronitrile), 37 parts by mass of propylene glycol monomethyl ether acetate, and 21 parts by mass of methyl lactate was added dropwise over a period of 3 hours and stirred at 65° C. for 3 hours and then at 95° C. for an hour to give a solution of (meth)acrylic polymer (P-1) (solid content: 45% by mass).

The acid number and the weight average molecular weight of the P-2 were measured in a manner similar to the manner in the Synthesis Example 1 and found to respectively be 80 mg KOH/g and 32,000.

### [Preparation of Resin Varnish CLV-1 for Forming Cladding Layer]

84 parts by mass (solid content: 38 parts by mass) of the P-1 solution (solid content: 45% by mass) as the base polymer (A); 33 parts by mass of urethane (meth)acrylate having a polyester backbone (“U-200AX” from Shin-Nakamura Chemical Co., Ltd.), 15 parts by mass of urethane (meth)acrylate having a polypropyleneglycol backbone (“UA-4200” from Shin-Nakamura Chemical Co., Ltd.), and 20 parts by mass (solid content: 15 parts by mass) of a polyfunctional block isocyanate solution, which is isocyanurate trimer of hexamethylene diisocyanate protected with methyl ethyl ketone oxime, (solid content: 75% by mass) (“Sumidur BL3175” from Sumitomo Bayer Urethane Co., Ltd.) as the photocurable component (B), 1 parts by mass of 1-[4-(2-hydroxyethoxy)phenyl]-2-hydroxy-2-methyl-1-propan-1-one (“Irgacure 2959” from Ciba Japan K.K.) and 1 parts by mass of bis(2,4,6-trimethylbenzoyl)phenylphosphine oxide (“Irgacure 819” from Ciba Japan K.K.) as the photopolymerization initiator (C); and 23 parts by mass of propylene glycol monomethyl ether acetate as a diluent organic solvent were mixed with stirring. The mixture was pressure-filtered through a Polyflon filter having a pore size of 2 μm (“PF020” from Advantec Toyo Kaisha, Ltd.) and then degassed under reduced pressure to give a resin varnish for forming a cladding layer.

### [Production of Resin Film CLF-1 for Forming Cladding Layer]

The resin composition for forming a cladding layer, the composition being obtained as described above, was applied to an untreated surface of a PET film (“Cosmoshine A4100” from Toyobo Co., Ltd. having a thickness of 50 μm) using the coater. After the composition was dried at 100° C. for 20 minutes, a PET film that was surface-treated with a release agent (“Purex A31” from Teijin DuPont Films Japan Ltd. having a thickness of 25 μm) was applied as a protective film to give the resin film for forming a cladding layer. The thickness of the resin layer could be optionally adjusted by adjusting a gap in the coater. The thickness of first lower cladding layers and second lower cladding layers (adhesive layers) used in the examples are described in the examples. The film thickness after curing the first lower cladding layers and the second lower cladding layers was the same as the thickness after applying the resin composition. The thickness of the resin films for forming an upper cladding layer, the films being used in the examples, are also described in the examples. In the examples, the thickness of the resin films for forming an upper cladding layer refers to the thickness after applying the resin composition.

### Example 1

### Preparation of Resin Varnish COV-1 for Forming Core Array

60 parts by mass of the P-2 solution (solid content: 45% by mass) as the alkali-soluble (meth)acrylic polymer (A), 40 parts by mass of bisphenol A epoxy acrylate (EA-1010N from Shin-Nakamura Chemical Co., Ltd.) (epoxy equivalent: 518 g/eq) as the polymerizable compound (B)

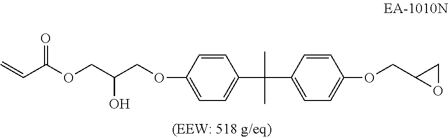 [SMILES: C=CC(=O)OCC(O)COc1ccc(C(C)(C)c2ccc(OCC3CO3)cc2)cc1]

1 part by mass of 1-[4-(2-hydroxyethoxy)phenyl]-2-hydroxy-2-methyl-1-propan-1-one (Irgacure 2959 from Ciba Specialty Chemicals K.K.) and 1 part by mass of bis(2,4,6-trimethylbenzoyl)phenylphosphine oxide (Irgacure 819 from Ciba Specialty Chemicals K.K.) as the polymerization initiators (C) were weighed into a wide-mouthed poly-bottle and stirred at a temperature of 25° C. for 6 hours using a stirrer at a rotation speed of 400 rpm to prepare a resin varnish for forming a core array. Then, the mixture was pressure-filtered through a Polyflon filter (PF020 from Advantec Toyo Kaisha, Ltd.) having a pore size of 2 μm and a membrane filter (J050A from Advantec Toyo Kaisha, Ltd.) having a pore size of 0.5 μm at a temperature of 25° C. and a pressure of 0.4 MPa. Then, the mixture was degassed for 15 minutes under reduced pressure using a vacuum pump and bell jar at a vacuum of 50 mmHg to give the resin varnish COV-1 for forming a core array.

### [Production of Resin Film COF-1 for Forming Core Array]

The resin varnish COV-1 for forming a core array was applied to an untreated surface of a PET film (A1517 from Toyobo Co., Ltd. having a thickness of 16 μm) using a coater (Multicoater TM-MC from Hirano Tecsheed Co., Ltd.) and dried at 100° C. for 20 minutes. Then, a releasable PET film (A31 from Teijin DuPont Films Japan Ltd. having a thickness of 25 μm) was applied as a protective film to give the resin film COF-1 for forming a core array. The thickness of the resin layer could be optionally adjusted by adjusting a gap in the coater. In the example, the gap was adjusted so that the film has a cured thickness of 50 μm.

### Examples 2 to 6 and Comparative Examples 1 and 2

Resin varnishes COV-2 to 8 for forming a core array were prepared according to compositions illustrated in a Table 1, and resin films COF-2 to 8 for forming a core array were produced in a manner similar to the manner in the Example 1.

[Measurement of Light Transmission at Wavelength of 850 nm]

After removing the protective film (Purex A31), the resin films for forming a core array were laminated to a glass slide (size: 76 mm×26 mm, thickness: 1 mm) at a pressure of 0.4 MPa and a temperature of 50° C. for a pressurization period of 30 seconds using the vacuum laminator. Then, the films were irradiated with UV light (at a wavelength of 365 nm) at 1000 mJ/cm² using the UV exposure device and heated at 160° C. for an hour to produce samples for measuring light transmission. The samples were measured for light transmission at a wavelength of 850 nm using a spectrophotometer (“U-3310” from Hitachi High-Technologies Corp.).

### [Measurement of Refractive Index]

The resin films for forming a core array were laminated to a silicon substrate (size: 60 mm×20 mm, thickness: 0.6 mm) in a manner similar to the manner in preparation of the samples for measuring light transmission and cured to produce samples for measuring refractive index. The samples were measured for refractive index at a wavelength of 830 nm using a prism-coupler refractometer (“Model 2020” from Metricon Corp.).

### [Method for Producing Optical Waveguide]

After removing the protective film (Purex A31), the resin film CLF-1 for forming the lower cladding layer was laminated to a glass epoxy substrate (“MCL-E-679FB” from Hitachi Chemical Co., Ltd. having a thickness of 0.6 mm, after the copper foil was removed by etching) using a vacuum pressure laminator (“MVLP-500/600” from Meiki Co., Ltd.) at a pressure of 0.4 MPa and a temperature of 80° C. for a pressurization period of 30 seconds. Then, the resin film was irradiated with UV light (at a wavelength of 365 nm) at 4000 mJ/cm² using a UV exposure device (“MAP-1200-L” from Dainippon Screen Mfg. Co., Ltd.), and then the support film (Cosmoshine A4100) was removed. The resultant film was heated at 120° C. for an hour to give the lower cladding layer 6.

Then, after the protective film (Purex A31) was removed, the resin film COF-1 for forming a core array was laminated to the lower cladding layer 6 using a roll laminator (“HLM-1500” from Hitachi Chemical Techno-Plant. Co., Ltd.) at a pressure of 0.5 MPa, a temperature of 50° C., and a rate of 0.2 m/min. Then, the resin film was irradiated with UV light (at a wavelength of 365 nm) at 2500 mJ/cm² through a negative photomask that had a pattern for forming an optical waveguide and that had a width of 50 μm using the UV exposure device to expose the core array 2 (core pattern). After the support film (Cosmoshine A1517) was removed, the resin film was developed in a 1% by mass aqueous solution of sodium carbonate using a spray developer (“RX-40D” from Yamagata Machinery Co., Ltd.) at a temperature of 30° C. and a spray pressure of 0.15 MPa for a development period of 105 seconds. Then, the film was washed with pure water and then heat-dried and thermal-cured at 160° C. for an hour.

After the protective film (Purex A31) was removed, the resin film CLF-1 for forming an upper cladding layer was laminated to the core array 2 and the lower cladding layer 6 using the vacuum pressure laminator at a pressure of 0.4 MPa and a temperature of 80° C. for a pressurization period of 30 seconds. The resin film was irradiated with UV light (at a wavelength of 365 nm) at 4000 mJ/cm². After the support film (Cosmoshine A4100) was removed, the resin film was heat-cured at 160° C. for an hour to form the upper cladding layer 5, thereby obtaining the optical waveguide 1 illustrated in FIG. 1A. Then, the waveguide was cut out into a rigid optical waveguide having a length of 10 cm using a dicing saw (“DAD-341” from Disco Corp.).

### [Measurement of Optical Loss]

The optical propagation loss of the resultant optical waveguide was measured using VCSEL having a center wavelength of 850 nm (“FLS-300-01-VCL” from EXFO Inc.) as a light source, a light-receiving sensor (“Q82214” from Advantest Corp.), an incident fiber (GI-50/125 multimode fiber, NA=0.20), and an output fiber (SI-114/125, NA=0.22). The optical propagation loss was calculated by dividing the optical loss value (dB) by the optical waveguide length (10 cm).

Evaluation results of the Examples 1 to 6 and the Comparative Examples 1 and 2 are illustrated in the Table 1, and the cross section of the optical waveguide in the Example 1 is illustrated in FIGS. 1A and 1B.

TABLE 1

| | | Ex. 1 | Ex. 2 | Ex. 3 | E. 4 | Ex. 5 | Ex. 6 | Comp. Ex. 1 | Comp. Ex. 2 |
|---|---|---|---|---|---|---|---|---|---|
| | Components | COV-1 | COV-2 | COV-3 | COV-4 | COV-5 | COV-6 | COV-7 | COV-8 |
| Item | (parts by mass) | (COF-1) | (COF-2) | (COF-3) | (COF-4) | (COF-5) | (COF-6) | (COF-7) | (COF-8) |
| Component | Base Polymer (P-2) | 60 (Solid | 60 (Solid | 60 (Solid | 60 (Solid | 60 (Solid | 60 (Solid | 60 (Solid | 60 (Solid |
| (A) | | Content) | Content) | Content) | Content) | Content) | Content) | Content) | Content) |
| Component | EA-1010N | 40 | 30 | 20 | — | — | — | — | — |
| (B) | EA-6310 | — | — | — | 40 | 30 | 20 | — | — |
| | FA-324A | — | 5 | 10 | — | 5 | 10 | 20 | 15 |
| | FA-321A | — | 5 | 10 | — | 5 | 10 | 20 | 15 |
| | NC-3000 | — | — | — | — | — | — | — | 10 |
| Component | 2959 | 1 | 1 | 1 | 1 | 1 | 1 | 1 | 1 |
| (C) | 819 | 1 | 1 | 1 | 1 | 1 | 1 | 1 | 1 |
| Evaluation | Film Index | 1.558 | 1.557 | 1.556 | 1.557 | 1.556 | 1.557 | 1.555 | 1.556 |
| | Film Transmission | 99.3 | 99.1 | 99.1 | 99.0 | 99.1 | 99.2 | 99.2 | 99.0 |
| | (850 nm) | | | | | | | | |
| | Optical Propagation | 0.06 | 0.14 | 0.16 | 0.07 | 0.14 | 0.17 | 0.22 | 0.25 |
| | Loss (dB/cm) | | | | | | | | |

1) (Meth)acrylic polymer solution produced in the Synthesis Example 2 (weight average molecular weight: 3.2×10⁴, acid number: 80 mg KOH/g)

2) Bisphenol A epoxy acrylate (“EA-1010N” from Shin-Nakamura Chemical Co., Ltd. having an epoxy equivalent of 518 g/eq)

3) Phenol novolac epoxy acrylate (“EA-6310” from Shin-Nakamura Chemical Co., Ltd. having an epoxy equivalent of 494 g/eq)

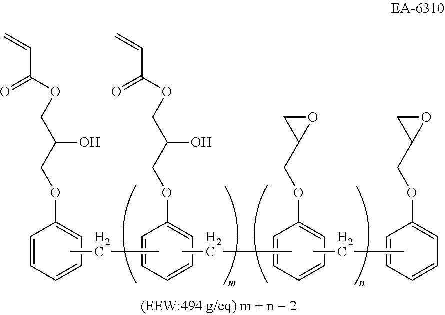

4) Ethoxylated bisphenol A diacrylate (“Fancryl FA-324A” from Hitachi Chemical Co., Ltd.)

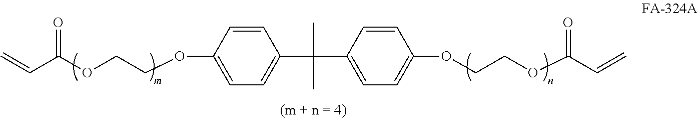

5) Ethoxylated bisphenol A diacrylate (“Fancryl FA-321A” from Hitachi Chemical Co., Ltd.)

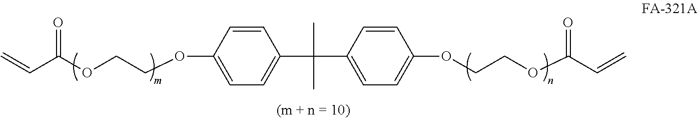

6) Phenol biphenylene epoxy resin (“NC-3000” from Nippon Kayaku Co., Ltd. having an epoxy equivalent of 275 g/eq)

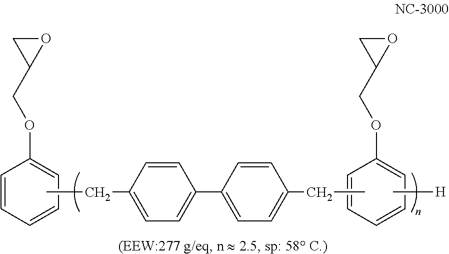

7) 1-[4-(2-hydroxyethoxy)phenyl]-2-hydroxy-2-methyl-1-propan-1-one (“Irgacure 2959” from BASF Japan Ltd.)

8) bis(2,4,6-trimethylbenzoyl)phenylphosphine oxide (“Irgacure 819” from BASF Japan Ltd.)

As illustrated in the Examples 1 to 6, the resin composition for forming an optical waveguide according to the present invention has high transparency. Optical waveguides were produced by the above method for producing an optical waveguide and measured for optical propagation loss. The results can confirm that the resin compositions for forming an optical waveguide, the compositions including EA-6310 or EA-1010N, exhibited low optical propagation loss and that the optical waveguides that includes the resin that includes 40 parts by mass of EA-6310 or EA-1010N respectively exhibited an optical propagation loss of 0.06 dB/cm or 0.07 dB/cm, which was significantly lower than 0.22 dB/cm in the Comparative Example 1 and 0.25 dB/cm in the Comparative Example 2.

### [Measurement of Refractive Index Before and After Immersion]

To determine difference between the refractive index of a surface layer of the core pattern and the refractive index of a central portion of the core pattern in the optical waveguides produced using the resin composition for forming an optical waveguide according to the present invention, refractive indices of the resin film for forming the core array before and after immersion in an alkali developer were measured in a following manner. The refractive indices were measured at a predetermined constant temperature in the range of from 15 to 30° C. (for example 25° C.).

In a manner similar to the manner for the samples for measuring light transmission, the resin film for forming the core array was laminated to a silicon substrate (size: 60 mm×20 mm, thickness: 0.6 mm) and irradiated with UV light (at a wavelength of 365 nm) at 2500 mJ/cm² using the UV exposure device, and then samples A and B were produced in a following manner:
Sample A: by heating at 160° C. for an hour
Sample B: by immersion in a 1% by mass aqueous solution of potassium carbonate at a temperature of 30° C. for two minutes and heating at 160° C. for an hour

In addition, the resin film for forming the core array was laminated in a manner similar to the manner for the samples for measuring light transmission, and then samples C and D were produced in a following manner:
Sample C: by irradiation with UV light (at a wavelength of 365 nm) at 2500 mJ/cm² using the UV exposure device
Sample D: by irradiation with UV light (at a wavelength of 365 nm) at 2500 mJ/cm² using the UV exposure device and immersion in a 1% by mass aqueous solution of potassium carbonate at a temperature of 30° C. for 2 minutes

Then, the samples A, B, C, and D were measured for refractive index at a wavelength of 830 nm using the prism-coupler refractometer. The measurements in Examples 7 and 8 and a Comparative Example 3 are illustrated in a Table 2 below.

TABLE 2

| Item | | A | B | C | D |
|---|---|---|---|---|---|
| Ex. 7 | COV-1 (COF-1) | 1.558 | 1.556 | 1.549 | 1.552 |
| Ex. 8 | COV-2 (COF-2) | 1.557 | 1.555 | 1.548 | 1.551 |
| Comp. Ex. 3 | COV-8 (COF-8) | 1.556 | 1.560 | 1.554 | 1.558 |

The results illustrated in the Table 2 show that the films in the Examples 7 and 8 satisfied the relationships of A>B, A−C≧0.003, A−C>D−C, and C<D. In contrast, the film in the Comparative Example 3 exhibited the relationships of A<B, A−C<0.003, and A−C<D−C. Thus, it has been confirmed that a reason for why the optical waveguide of the present invention has a low optical propagation loss is that the surface layer of the core pattern that forms the core array can have a refractive index that is lower than the refractive index of a central portion of the core pattern, as clear from the Table 2.

### INDUSTRIAL APPLICABILITY

The resin composition for forming an optical waveguide according to the present invention has high transparency and includes a portion immersed in an alkali developer, the portion having a lower refractive index. An optical waveguide produced using the resin composition is far superior in optical propagation properties.

1. A resin composition for forming an optical waveguide, the composition comprising:
(A) a polymer;
(B) a polymerizable compound; and
(C) a polymerization initiator;
wherein a refractive index A at a predetermined wavelength (λ) in the range of from 830 to 850 nm of a film produced by forming the composition into a film, irradiating the film with UV light (at a wavelength of 365 nm) at a predetermined dose (X) in the range of from 1000 to 4000 mJ/cm², and then heating the film at a predetermined temperature (T1) in the range of from 160 to 180° C. for a predetermined period (H1) in the range of from 0.5 to 3 hours and a refractive index B at the predetermined wavelength (λ) of a film produced by forming the composition into a film, irradiating the film with UV light (at a wavelength of 365 nm) at the predetermined dose (X), then immersing the film in an aqueous potassium carbonate solution having a predetermined concentration (C1) in the range of from 0.5 to 5% by mass at a predetermined temperature (T2) in the range of from 20 to 40° C. for a predetermined period (H2) in the range of from 1 to 5 minutes, and then heating the film at the predetermined temperature (T1) for the predetermined period (H1) satisfy the relationship of A>B.

2. A resin composition for forming an optical waveguide, the composition comprising:
(A) a polymer;
(B) a polymerizable compound; and
(C) a polymerization initiator;
wherein a refractive index A at a predetermined wavelength (λ) in the range of from 830 to 850 nm of a film produced by forming the composition into a film, irradiating the film with UV light (at a wavelength of 365 nm) at a predetermined dose (X) in the range of from 1000 to 4000 mJ/cm², and then heating the film at a predetermined temperature (T1) in the range of from 160 to 180° C. for a predetermined period (H1) in the range of from 0.5 to 3 hours and a refractive index C at the predetermined wavelength (λ) of a film produced by forming the composition into a film and irradiating the film with UV light (at a wavelength of 365 nm) at the predetermined dose (X) satisfy the relationship of A−C≧0.003.

3. A resin composition for forming an optical waveguide, the composition comprising:
(A) a polymer;
(B) a polymerizable compound; and
(C) a polymerization initiator;
wherein a refractive index A at a predetermined wavelength (λ) in the range of from 830 to 850 nm of a film produced by forming the composition into a film, irradiating the film with UV light (at a wavelength of 365 nm) at a predetermined dose (X) in the range of from 1000 to 4000 mJ/cm², and then heating the film at a predetermined temperature (T1) in the range of from 160 to 180° C. for a predetermined period (H1) in the range of from 0.5 to 3 hours, a refractive index C at the predetermined wavelength (λ) of a film produced by forming the composition into a film and irradiating the film with UV light (at a wavelength of 365 nm) at the predetermined dose (X), and a refractive index D at the predetermined wavelength (λ) of a film produced by forming the composition into a film, irradiating the film with UV light (at a wavelength of 365 nm) at the predetermined dose (X), then immersing the film in an aqueous potassium carbonate solution having a predetermined concentration (C1) in the range of from 0.5 to 5% by mass at the predetermined temperature (T2) for the predetermined period (H2) satisfy the relationship of A−C>D−C.

4. The resin composition for forming an optical waveguide according to claim 1,
wherein a refractive index C at a predetermined wavelength (λ) in the range of from 830 to 850 nm of a film produced by forming the composition into a film and irradiating the film with UV light (at a wavelength of 365 nm) at a predetermined dose (X) in the range of from 1000 to 4000 mJ/cm² using a UV exposure device and a refractive index D at the predetermined wavelength (λ) of a film produced by forming the composition into a film, irradiating the film with UV light (at a wavelength of 365 nm) at the predetermined dose (X) using a UV exposure device, and then immersing the film in an aqueous potassium carbonate solution having a predetermined concentration (C1) in the range of from 0.5 to 5% by mass at a predetermined temperature (T2) in the range of from 20 to 40° C. for a predetermined period (H2) in the range of from 1 to 5 minutes satisfy the relationship of C<D.

5. The resin composition for forming an optical waveguide according to claim 1,
wherein the polymer (A) comprises an alkali-soluble polymer having a carboxyl group, and the polymerizable compound (B) comprises a compound having an epoxy group and an ethylenically unsaturated group per molecule.

6. A resin composition for forming an optical waveguide, the composition comprising:
(A) a polymer;
(B) a polymerizable compound; and
(C) a polymerization initiator,
wherein the polymer (A) comprises an alkali-soluble polymer having a carboxyl group, and the polymerizable compound (B) comprises a compound having an epoxy group and an ethylenically unsaturated group per molecule.

7. The resin composition for forming an optical waveguide according to claim 1,
wherein the compound having an epoxy group and an ethylenically unsaturated group per molecule contains an aliphatic ring or aromatic ring per molecule.

8. The resin composition for forming an optical waveguide according to claim 1,
wherein the compound having an epoxy group and an ethylenically unsaturated group per molecule has at least one epoxy group and at least one ethylenically unsaturated group per molecule.

9. The resin composition for forming an optical waveguide according to claim 1,
wherein the compound having an epoxy group and an ethylenically unsaturated group per molecule has a bisphenol backbone in its molecule.

10. The resin composition for forming an optical waveguide according to claim 1,
wherein the composition comprises, as the polymerizable compound (B), at least one of a compound containing two or more ethylenically unsaturated groups per molecule and a compound containing two or more epoxy groups per molecule, in addition to the compound containing an epoxy group and an ethylenically unsaturated group per molecule.

11. The resin composition for forming an optical waveguide according to claim 1,
wherein the polymer (A) having a carboxyl group has a weight average molecular weight of from 1,000 to 3,000,000.

12. The resin composition for forming an optical waveguide according to claim 1,
wherein the polymer (A) having a carboxyl group has a maleimide backbone in the main chain.

13. The resin composition for forming an optical waveguide according to claim 1,
wherein the polymer (A) is contained in an amount of from 10 to 85% by mass based on the total amount of the polymer (A) and the polymerizable compound (B), the polymerizable compound (B) is contained in an amount of from 15 to 90% by mass based on the total amount of the polymer (A) and the polymerizable compound (B), and the polymerization initiator (C) is contained in amount of from 0.1 to 10 parts by mass based on 100 parts by mass of the total amount of the polymer (A) and the polymerizable compound (B).

14. The resin composition for forming an optical waveguide according to claim 1,
wherein the polymer (A) is contained in an amount of from 10 to 65% by mass based on the total amount of the polymer (A) and the polymerizable compound (B), and the polymerizable compound (B) is contained in an amount of from 35 to 90% by mass based on the total amount of the polymer (A) and the polymerizable compound (B).

15. A resin film for forming an optical waveguide, the film comprising a resin layer that is obtained using the resin composition for forming an optical waveguide according to claim 1.

16. The resin film for forming an optical waveguide according to claim 15, the film having a three-layered structure comprising a substrate film, the resin layer, and a protective film.

17. An optical waveguide comprising:
a lower cladding layer;
a core array; and
an upper cladding layer,
wherein at least one of the lower cladding layer, the core array, and the upper cladding layer is formed using the resin composition for forming an optical waveguide according to claim 1.

18. The optical waveguide according to claim 17,
wherein the core array is formed using the resin composition for forming an optical waveguide.

19. The optical waveguide according to claim 18,
wherein light mainly travels through a high-refractive-index portion inside of the core array.

20. The optical waveguide according to claim 17,
wherein the waveguide exhibits an optical propagation loss equal to or less than 0.15 dB/cm at a wavelength of 850 nm.

21. A method for producing an optical waveguide, the method comprising:
laminating the resin composition for forming an optical waveguide according to claim 1;
exposing the composition;
developing the composition in an alkali developer; and
thermal-curing the composition to form at least one of a lower cladding layer, a core array, and an upper cladding layer.

22. An optical waveguide comprising:
a lower cladding layer;
a core array; and
an upper cladding layer,
wherein at least one of the lower cladding layer, the core array, and the upper cladding layer is formed using the resin film for forming an optical waveguide according to claim 15.

23. The optical waveguide according to claim 22,
wherein the core array is formed using the resin film for forming an optical waveguide.

24. The optical waveguide according to claim 23,
wherein light mainly travels through a high-refractive-index portion inside of the core array.

25. The optical waveguide according to claim 22,
wherein the waveguide exhibits an optical propagation loss equal to or less than 0.15 dB/cm at a wavelength of 850 nm.

26. A method for producing an optical waveguide, the method comprising:
laminating the resin film for forming an optical waveguide according to claim 15;
exposing the film;
developing the film in an alkali developer; and
thermal-curing the film to form at least one of a lower cladding layer, a core array, and an upper cladding layer.
